(19) United States
(12) Patent Application Publication
(10) Pub. No.: US 2008/0005680 A1
(43) Pub. Date: Jan. 3, 2008

(54) Electronic Calendar

(75) Inventor: Kevin Greenlee, Lee's Summit, MO (US)

Correspondence Address: LATHROP & GAGE LC, 2345 GRAND AVENUE, SUITE 2800, KANSAS CITY, MO, 64108, US

(73) Assignee: ANDREWS MCMEEL PUBLISHING, INC., Kansas City, MO (US)

(21) Appl. No.: 11/750,737

(22) Filed: May 18, 2007

Related U.S. Application Data
(60) Provisional application No. 60/801,537, filed on May 18, 2006.

(51) Int. Cl. G06F 3/00

(52) U.S. Cl. 715/748

(57) ABSTRACT

An electronic calendar includes calendar pages that can be displayed electronically, on a computer screen or the like. The electronic calendar may be loadable onto a computer system from a disc or the like, or downloaded from a server, over a network, such as the Internet. The electronic calendar is integratable with other calendaring and scheduling functions, and can may carry links that when clicked or activated provide a uniform resource locator to a user's browser or browsing application.

### CROSS-REFERENCES TO RELATED APPLICATIONS

This application claims priority from and is related to commonly owned U.S. Provisional Patent Application Ser. No. 60/801,537, entitled: Electronic Calendar, filed on May 18, 2006, and the disclosure of which is incorporated by reference herein.

### TECHNICAL FIELD

The present disclosed subject matter is directed to electronic data, typically in the form of electronic calendars. In particular, the present disclosed subject matter is directed to systems and methods for obtaining the data including the electronic calendars as well as electronic calendars that incorporate features of computer applications into the calendar.

### BACKGROUND

Themed calendars continue to increase in popularity worldwide. These themed calendars are typically paper calendars in a pad-like form, with a page for each day, or separate pages for each day and one page for the weekend days, that are removable from the pad. Each page typically includes text and/or illustrations about the calendar theme. Once the requisite day has passed, the pages are removed, and saved or thrown away. This continues until the end of a calendar year. Additionally, these calendars are typically organized based on a year, from January 1 to December 31. Accordingly, the page for January 1 is the first or top page, while the page for December 31 is the last or bottom page.

Accordingly, retailers can command high prices for such calendars before January 1. However, as the year goes on, the price drops, as fewer pages of the calendar are relevant. Retailers are forced to sell these calendars at severe discounts or face a total loss on any remaining stock. Additionally, more consumers are turning to electronic or on line purchasing for numerous items, and accordingly, the brick and mortar store is giving way to the electronic or digital store.

Another drawback of these conventional calendars is that they take up desk, shelf or cube space, which is at a premium in most offices, as employers are trying to fit as many employees into as little space as possible. Also, the sight of these calendars tends to attract others into personal workspace, a typically unwanted situation, especially when the worker is not present at the workspace. This leads to invasions of personal space as well as the calendar being subject to mishandling, vandalism, page theft and being broken.

### SUMMARY

The disclosed subject matter is directed to systems and methods for providing electronic data, typically in the form of electronic calendars, and delivering electronic calendars directly to users' computers. The electronic calendars are, for example, day-to-day calendars, that when in the traditional paper form, each day is represented by a sheet, which is severable from the remaining sheets of the calendar. The electronic calendar is obtainable in various forms, two exemplary forms being on a compact disc (CD) or other storage media, or downloadable over a network, in, for example, a downloadable install package, the network such as a public network like the Internet, a Wide area network (WAN), or a local area network (LAN).

The disclosed subject matter includes an electronic calendar, whose calendar pages can be displayed electronically, on a computer screen or the like. The disclosed electronic calendar may be loadable onto a computer system from a disc or other storage medium, or downloaded to the computer system from a server (or other storage device linked to a network), over a network, such as the Internet.

The disclosed subject matter is directed to systems and methods for obtaining the data including the electronic calendars as well as electronic calendars that incorporate features of computer applications into the calendar. These features include, for example, time based features and other applications typically associated with calendars, calendar segments and other personal, business and organizational applications, typically found on, for example, personal computers, cellular telephones, including smartphones, personal digital assistants, Blackberry®, iPhones™, and the like.

The disclosed subject matter includes electronic calendars and related electronic data, that are useful with personal computers, workstations and the like, which are typically in an employee's workspace. During most of the day, people perform their work in front of their computers. Accordingly, the themed electronic calendars of the disclosed subject matter may be enjoyed by these employees as well as others who spend large amounts of time in front of their computer.

The disclosed electronic calendars are available in various time periods, and are suitable for year round purchase and install. For example, a purchase on April 1 may be for a calendar for one year beginning April 1, or another predetermined time period beginning April 1, or for a year or other time period beginning on any desired date accordingly, the disclosed electronic calendars are not limited to a standard January 1 to December 31 calendar year.

The disclosed electronic calendar includes data, that when converted into an calendar page file (corresponding to a calendar page), typically corresponds to a predetermined time interval, such as a day or days. The electronic data is typically integrated with applications, such as the calendar and scheduling programs, for example, from Microsoft® Outlook®, Gmail™, iCal™, Lotus® Notes®, and functionalities, including embedded links with uniform resource locators of target web sites (to direct the user's browser or browsing application to these target web sites). The electronic data of the disclosed electronic calendar is also integratable with multimedia components, such as sounds, video, combinations thereof, and the like.

The disclosed subject matter is such that pages of calendar portions with other functions such as appointment lists or the like may be printed as pages by activating a print icon or print button of a dropdown menu, toolbar, or the like. Also, the disclosed subject matter can include space in which personal photos, uploaded into the computer can be placed. The space can accommodate numerous photos, that are interchangeable in the space, so as to be viewed when an icon or tool bar is activated.

The disclosed subject matter, for example, a calendar page, is displayed in a form, a frame, or the like, having a skin or border. This skin may be adjusted, stretched or shortened, in both length and width, similar to a regular window, by moving a curser to the boarder, activating the dimension changing function, and stretching or scaling the skin or border.

The disclosed subject matter also has the ability to issue meeting reminders, by integrating such functionalities with its calendar page displays. Data, such as news feeds, Real Simple Syndication (RSS) feeds and the like may also be received by the application. The calendar page display also includes space for accommodating icons corresponding to utilities, such as currency converters, weather, and the like, so as to pull other data from the world wide web (WWW).

The disclosed subject matter is directed to a computer usable storage medium. The medium is for storing data for an electronic calendar, and includes a plurality of electronic calendar page files, each of the electronic calendar page files corresponding to one or more dates, and a module. The module is for interacting with the plurality of electronic calendar page files. The module includes a first application for obtaining a date and accessing an electronic calendar page file corresponding to that obtained date, a second application for retrieving the accessed electronic calendar page file, and a third application for displaying the retrieved electronic calendar page file as an image.

The disclosed subject matter is directed to a server for storing an electronic calendar, that is downloadable over a network, e.g., the Internet. The server initially includes a storage medium for storing data for an electronic calendar. The stored data includes a plurality of electronic calendar page files, each of the electronic calendar page files corresponding to at least one date, a first application for obtaining a date and accessing an electronic calendar page file corresponding to the obtained date, a second application for retrieving the accessed electronic calendar page file, and, a third application for displaying the retrieved electronic calendar page file as an image. There is also a component for providing an application associated with the computer of a user access to the plurality of electronic calendar files, the first application, the second application and the third application.

The disclosed subject matter is directed to a method for distributing an electronic calendar. The method includes storing data for an electronic calendar, the data to be stored including, a plurality of electronic calendar page files, each of the electronic calendar page files corresponding to at least one date, a first application for obtaining a date and accessing an electronic calendar page file corresponding to that obtained date, a second application for retrieving the accessed electronic calendar page file, and a third application for displaying the retrieved electronic calendar page file as an image. The plurality of electronic calendar files, the first application, the second application and the third application, are then accessed.

The disclosed subject matter is directed to a computer usable storage medium, that has a computer program embodied thereon for causing a suitably programmed system to display an electronic calendar page for a date by performing steps when the program is executed on the system. The steps include, obtaining the date, obtaining the stored calendar page file corresponding to the obtained date from a plurality of stored calendar page files, and placing the obtained calendar page file into an application for it to be displayed as an image.

The disclosed subject matter is also directed to a method for year round use of an electronic calendar. The method includes, providing a plurality of electronic calendar pages (calendar page data stored in files or the like) arranged in a cycle to cover a predetermined time period, each of the electronic calendar pages corresponding to at least one date. Then, a calendar page as the first page of the cycle to be accessed is designated, followed by providing access to the electronic calendar pages as of the at least one date to which the designated calendar page corresponds.

The disclosed subject matter is also directed to a computer usable storage medium. The storage medium has a computer program embodied thereon for causing a suitably programmed system to allow for year round ordering use of an electronic calendar by performing the following steps when the program is executed on the system. The steps include, arranging a plurality of electronic calendar page files into a cycle to cover a predetermined time period, each of the electronic calendar pages corresponding to at least one date, designating an electronic calendar page file as first file of the cycle to be accessed, and providing access to the electronic calendar page files as of the at least one date to which the designated electronic calendar page file corresponds.

The disclosed subject matter is also directed to a method for obtaining an electronic calendar page. The method includes storing a plurality of electronic calendar page files in a storage device linked to a network, each of the plurality of electronic calendar page files corresponding to at least one date. A first application is provided for retrieving electronic calendar page files on the computer of a user. A second application is provided for displaying electronic calendar page files on the computer of a user. A request is then received for an electronic calendar page file corresponding to a date in the request, and the computer of the user is provided access to the electronic calendar page file corresponding to the date in the request.

The disclosed subject matter is also directed to a server for storing electronic calendar page files. The server is accessible over a network, such as the Internet. The server includes a storage medium for storing a plurality of electronic calendar page files, each of the plurality of electronic calendar page files corresponding to at least one date. It also includes a first component for receiving a request for an electronic calendar page file corresponding to a date in the request, and a second component for providing the an application associated with the computer of the user access to the electronic calendar page file corresponding to the date in the request.

### BRIEF DESCRIPTION OF THE DRAWINGS

Attention is now directed to the drawing figures, where like or corresponding numerals or characters indicate corresponding or like components. In the drawings:

FIG. 1 is a diagram of an exemplary system on which the methods of the disclosed subject matter are performed as well as electronic data, typically electronic calendars and associated data, are obtained and operated;

FIGS. 2A and 2B are screen display of a web pages used to order and obtain the calendars in accordance with the disclosed subject matter;

FIG. 2C is a screen display of a web page from which the calendars may be downloaded;

FIG. 3 is a flow diagram for creating calendar page files;

FIG. 4 is a flow diagram for encrypting the calendar.exe module;

FIG. 5A is a diagram for packaging the disclosed calendar on various media;

FIG. 5B is a detailed diagram of the support controls of FIG. 5A;

FIG. 5C is a flow diagram of an install process for the various media of FIG. 5A;

FIGS. 6A and 6B are screen displays of icons used to activate the disclosed calendars;

FIG. 7 is a diagram of the registration process;

FIGS. 8A and 8B are a flow diagram of a process performed by the calendar.exe module;

FIGS. 9A and 9B are screen displays of a button bar;

FIGS. 10A and 10B are screen displays of calendar forms with calendar pages;

FIG. 11 is a screen display of a calendar form with a calendar page;

FIG. 12 is a screen display of a calendar form with an active billboard;

FIG. 13 is a screen display of a calendar form with two active billboards;

FIG. 14 is a screen display of a calendar form illustrating a drop down menu;

FIGS. 15-21 are screen displays of calendar forms supporting various functionalities;

FIG. 22 is a screen display of an e-mail of a calendar page;

FIG. 23 is a diagram of a web-based application of the disclosed calendar;

FIGS. 24A and 24B are screen displays of calendar forms that support video and audio streams;

FIGS. 25A-25C are flow diagrams used in illustrating year round purchase and use of the disclosed calendars;

FIG. 26 is a diagram of a file set;

FIG. 27 is screen display of a calendar with a splash page;

FIG. 28 is a diagram detailing year round purchase and use of the disclosed calendars;

FIGS. 29-32 are screen displays of various calendar forms that support various calendar pages, to accompany the diagram of FIG. 28;

FIG. 33 is a flow diagram of an alternate process for accessing calendar page files over a network;

FIG. 34 is a flow diagram of an install process for the various media of FIG. 33; and,

FIG. 35 is a screen display of a calendar form retrieving the requisite calendar page over a network.

### DETAILED DESCRIPTION

Throughout this document, textual and graphical references are made to fictional trademarks as well as Internet addresses (Uniform Resource Locators, also known as URLs). These trademarks and Internet addresses are fictitious and for explanation purposes only, and any association with any party or other entity is coincidental, unintentional and unrelated thereto. Throughout this document, numerous textual and graphical references are made to trademarks. These trademarks are the property of their respective owners, and are referenced only for explanation purposes herein. Also, references are made to discs and disks for various computer devices and applications, and accordingly, these words are used interchangeably in this document.

Throughout this document, references are made to the term “click”, “clicks”, “clicking”, “click on”, “clicks on”, “clicking on”, and variations thereof. These terms refer to activating a mouse or other pointing device at an on-screen location to activate a button, link, or other activatable feature that appears on the screen of the user. The “click”, “clicks”, “clicking”, “click on”, “clicks on”, “clicking on”, is typically indicated by an arrow over or touching the requisite feature.

Moreover, throughout this document, the terms “web page” and “web site” are used interchangeably. A web site is a related collection of World Wide Web (WWW) files that includes a beginning file called a home page. This home page is one of the files or web pages that makes up the web site.

A uniform resource locator (URL) is the unique address for a file, such as a web site or a web page, that is accessible on the Internet.

A server is typically a remote computer or remote computer system, or computer program therein, that is accessible over a communications medium, such as the Internet, that provides services to other computer programs (and their users), in the same or other computers.

Electronic data, typically in the form of an electronic calendar and associated applications are disclosed. The electronic calendar is suitable for use with personal computers, that include storage media for storing the electronic calendar as transferred from the compact disc or downloaded. This storage media may include a standard hard drive. The electronic calendars are, for example, suitable for use with personal computers, work stations or the like, with Pentium® processors and Windows® or Apple® MAC® (e.g., MAC OSX) based operating systems or the like, along with an internet browsing applications, such as Internet Explorer® or the like, and a local program/player.

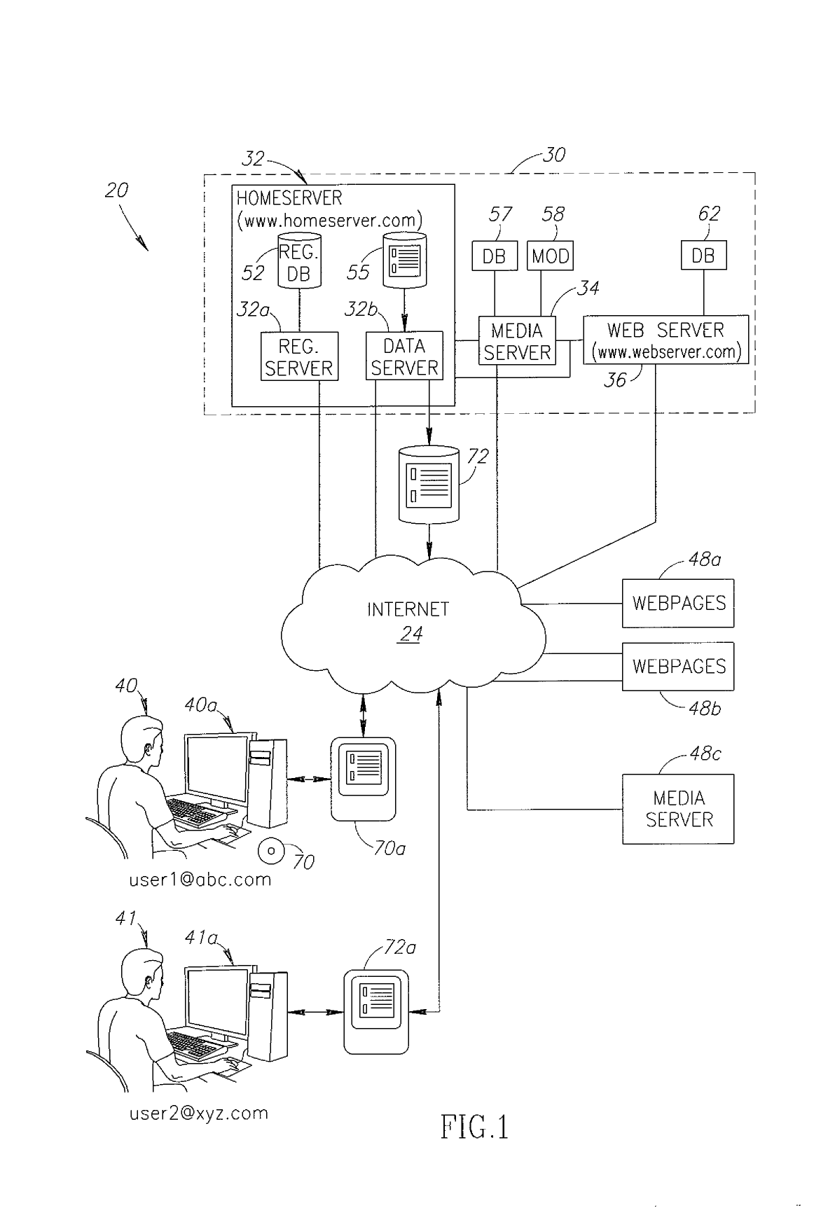

Turning to FIG. 1, there is shown an exemplary system 20, formed of various servers and server components, that are linked to a wide area network (WAN) or other public network, such as the Internet 24. The servers on which the electronic data, typically electronic calendars, and data associated therewith, are performed under the control of a controlling entity, represented by the broken line box 30, for the system associated with the controlling entity.

There are, for example, at least three kinds of servers that form the system 30 associated with the controlling entity. These servers typically include a Home Server (HS) 32, with a URL of www.homeserver.com, a media server 34, www.mediaserver.com, for providing content, and web servers 36, with a URL of www.webserver.com. While the aforementioned servers are shown as single servers, they may be formed of multiple servers and combinations thereof. These servers 32, 34, 36, are linked to each other via the Internet 24 and also through a private or local network, within the system 30. The servers 32, 34, 36 include processors and multiple components for performing the requisite functions as detailed below, and the components may be based in hardware, software, or combinations thereof. The servers 32, 34, 36 may also have internal storage media and/or be associated with external storage media.

The servers 32, 34, 36 of the system 30 are linked (either directly or indirectly) to an endless number of other servers and the like, via the Internet 24. Other servers, exemplary for describing the operation of the system 20, include domain servers (not shown) for the domains (for example, the domains “abc.com” and “xyz.com”) of the users 40, 41 (for example, whose electronic mail (e-mail) address are user1 abc.com and user2@xyz.com), for their respective computers 40a, 41a. Still other servers may include third party servers 48a-48c, controlled by content providers, web site promoters, and the like.

While various servers have been listed, this is exemplary only, as the disclosed subject matter can be performed on an endless numbers of servers and associated components, that are in some way linked to a network, such as the Internet 24. Additionally, all of the aforementioned servers include components for accommodating various server functions, in hardware, software, or combinations thereof, and typically include storage media, either therein or associated therewith. Also in this document, the aforementioned servers, storage media, and components can be linked to each other or to a network, such as the Internet 24, either directly or indirectly.

The Home Server (HS) 32 is formed of, for example, two servers, a registration (reg.) server 32a and a data server 32b. The registration server 32a is of an architecture that includes components, such as databases (DBs) and caches 52, modules and the like, for handling numerous operations and applications, associated with registering users to specific electronic data, typically electronic calendars. Similarly, the data server 32b is of an architecture that includes components, such as databases and caches 55, modules and the like, for handling numerous operations and applications, associated with storing and distributing specific electronic data, typically electronic calendars.

The home server (HS) 32 is shown for example, as a single server, but it may be made up of numerous servers along the public network (i.e., the Internet 24) or along a local network, or combinations thereof. The databases and caches, and nodules may be in single or separate components.

The media server 34 is formed of, for example, one server, but could also be formed of multiple servers and components. The media server 34 is of an architecture that includes components, such as databases and caches 57, and modules (MOD) 58, such as links to search engines and content associated with the electronic data, i.e., the electronic calendars, distributed and administered by the home server 32 (the data server 32b). The media server 34 is configured to push data to subscribers of the product, for example, the calendar, or provide for these subscribers to pull data from the media server 34.

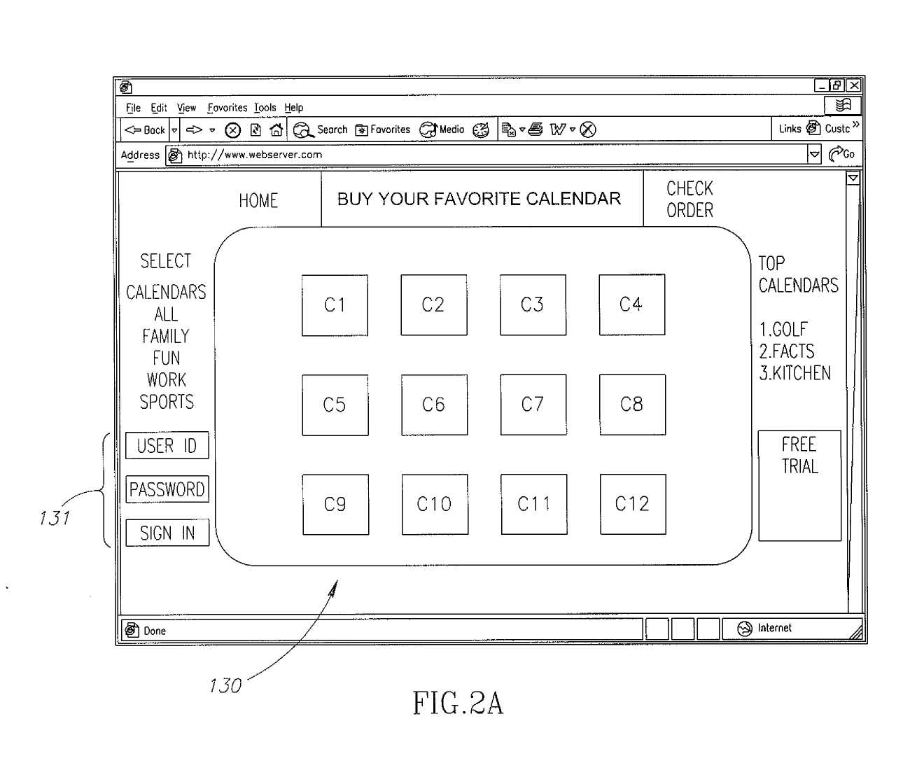

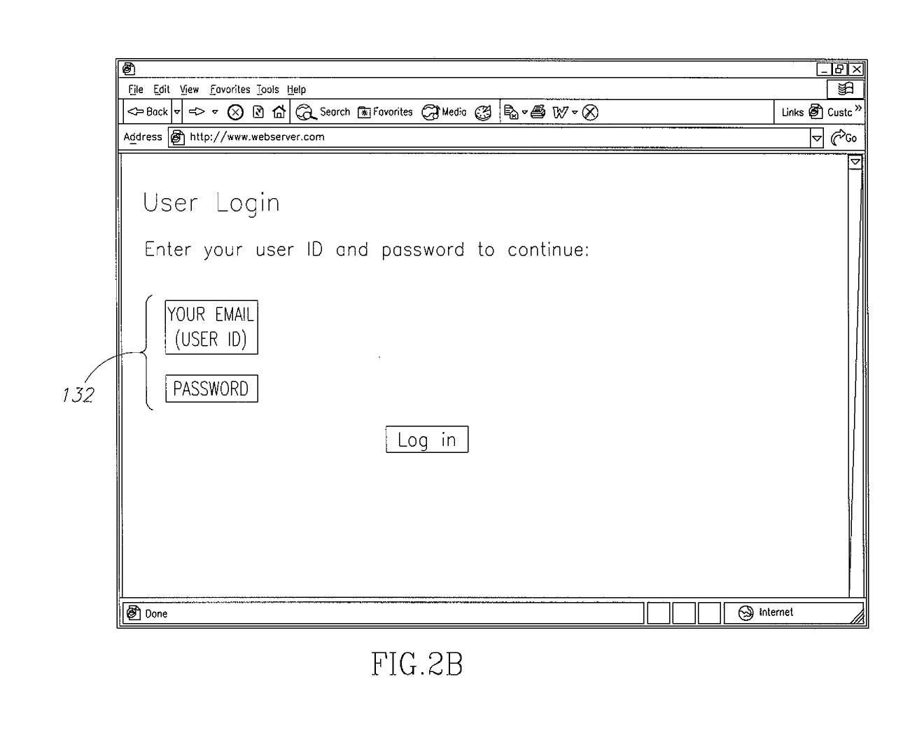

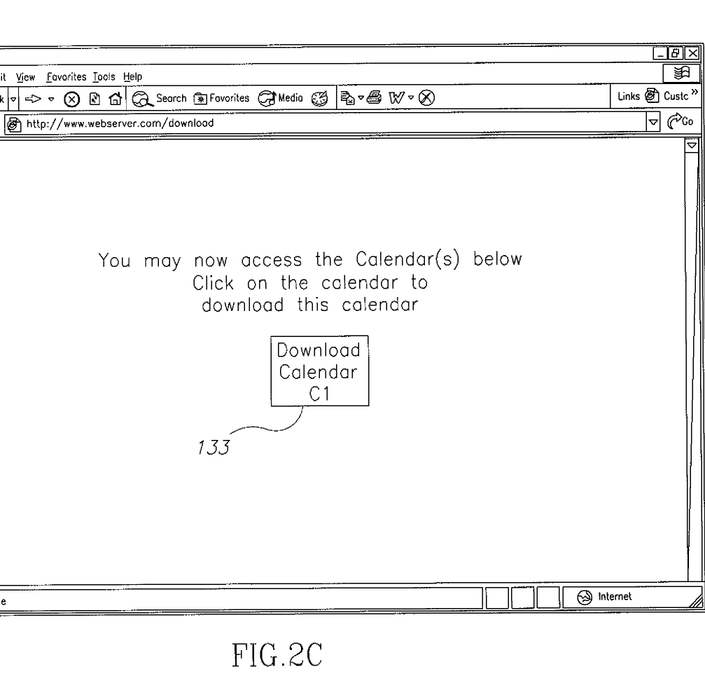

The web server 36 is formed of, for example, one server, but could also be formed of multiple servers and components. The web server 36 is of an architecture that includes components, such as databases 62 and caches, and modules, for orders and administration of orders for calendar and other related products. For example, the web server 36 hosts a web page 130, shown in FIG. 2A, on which the user can order various calendars C1-C9 or other electronic data items, or compact discs and other media containing the calendars C1-C9 and applications to run them on a personal computer or the like.

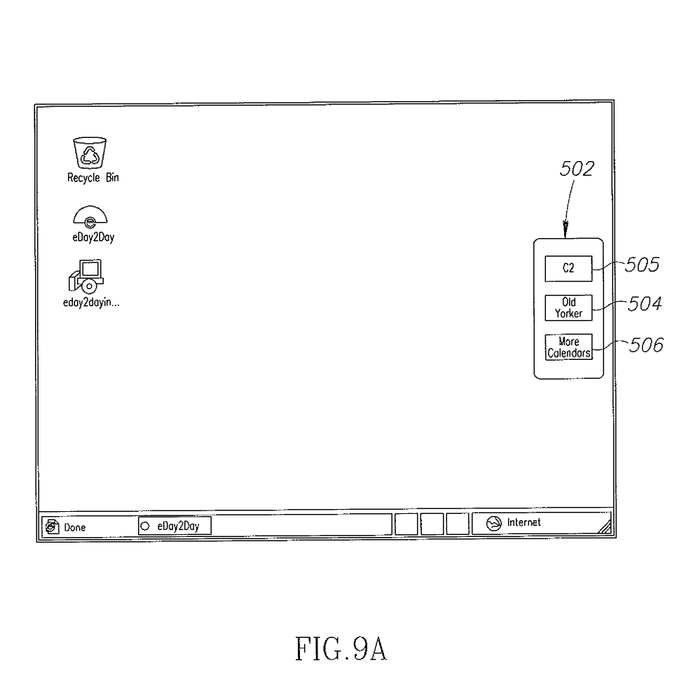

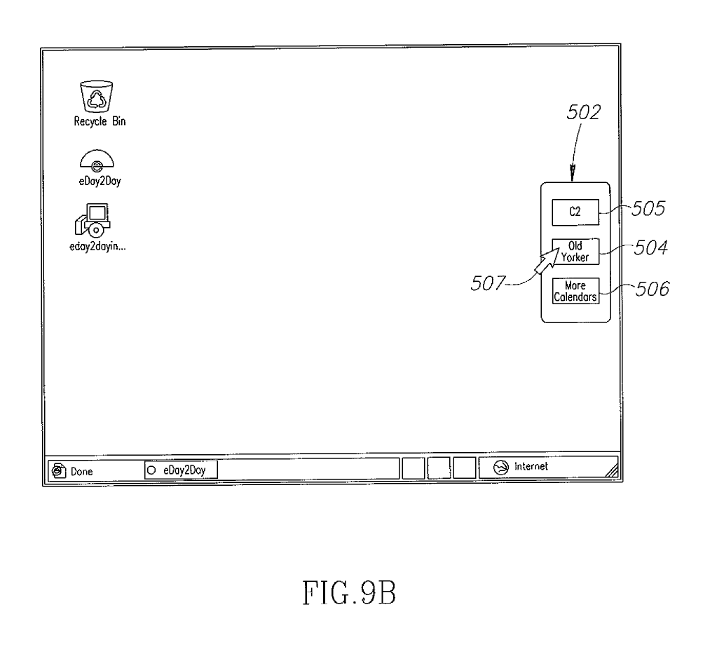

This web page 130 of FIG. 2A is accessed by the browsing application of a user, over the Internet 24, either manually (by the user entering the URL of www.webserver.com) or through a search engine or the like, or when the user activates buttons 506 (FIGS. 9A and 9B) or 644 (FIG. 1). The user's web browser or browsing application will be directed to this web site (web page) of the URL www.webserver.com. Once at the web site or web page, the user may order, for example, electronic publications such as electronic calendars. These calendars may be purchased and delivered on line or electronically, or ordered as compact discs (CD's) or other recorded media, and delivered by conventional postal mail or other conventional delivery services.

For example, with online ordering and/or online delivery, over a network, such as the Internet 24, once the user makes his selection of the calendar from the web page of FIG. 2A, he makes the requisite purchase. Once the purchase is finalized, the user sees the screen of FIG. 2B, where the user is prompted to enter their user ID and password in the area 132. If this information is correct, the user sees the screen of FIG. 2C, where they can download their purchased calendar, by clicking on the button 133. Once this button is clicked, the data server 32b is activated, to open the connection to the user's computer via the Internet 24, to facilitate the calendar download (where the user's browsing application typically pulls the requisite calendar pages including the programs and applications for operating the calendar on his computer).

Alternately, if this user does not want to download now, the connection will time out and the user will receive an e-mail with a direct link to the download screen of FIG. 2C. Alternately, the user can browse to the home page of FIG. 2A, enter his information in area 131, where he will be directed to the screen of FIG. 2C so that he can download the calendar.

Similarly, if a calendar has been purchased for a user, the user will receive an e-mail with a link to the download screen of FIG. 2C, where he can download the selected calendar. Alternately, should this user have an account already set up, the user can browse to the home page of FIG. 2A, enter his information in area 13 1, where he will be directed to the screen of FIG. 2C, so that he can download the calendar.

The third party servers 48a, 48b host web sites, web pages and the like, associated with particular URLs. The web sites correspond to URL's that are sent to the electronic data, for example, calendar forms 550 (FIG. 11), as embedded links. The links may be sent to the calendar pages by numerous known techniques, including Real Simple Syndication (RSS) feeds, multimedia files, and the like. When the embedded links are activated, typically by a mouse click on the link in the calendar, for example, the Advertisement, the user's browsing application or browser is directed to the web site hosted by the requisite third part server 48a, 48b. The third party servers 48a, 48b are representative of a multitude of servers linked to the Internet 24 and hosted by third parties associated with the URL of a target web site.

Another third party server 48c may provide applications, programs, applets, and the like, for RSS and other multimedia, or electronic data transmissions. This third party server 48c is representative of a multitude of other third party servers, that are linked to the Internet 24, hosted by a multitude of different parties.

A first user 40 is representative of users who have purchased an electronic calendar or other electronic media on a compact disc 70 or other prerecorded media. The user 40, loads the disc 70 into his computer 40a (the computer 40a, for example, a personal computer, workstation or computer type machine, with a Pentium® or other similar processor and a Windows® or Mac® operating system, with a suitable hard drive or the like). The user 40 accesses the internet 24 through a browsing application or browser, for example Internet Explorer® from Microsoft®. The computer 40a is linked to the registration server 32a, and a registration process may begin, so that the disc is authentic and its use is authorized. The calendar 70a from the disc, via the computer 40a, links to the network, such as the Internet 24, for various operations, as detailed below.

A second user 41, is representative of users who have purchased or are to receive an electronic calendar or other electronic media on-line, over the network, such as the Internet 24. The files for the purchased or to be received electronic calendar from the data server 32b as a download 72. The files for the electronic calendar or other electronic media are downloaded to the user's computer 41a (this computer 41a is similar to the computer 40a of user1 40), as detailed further below. The calendar 72a from the disc, via the computer 41a, links to the network, such as the Internet 24, for various operations, as detailed below.

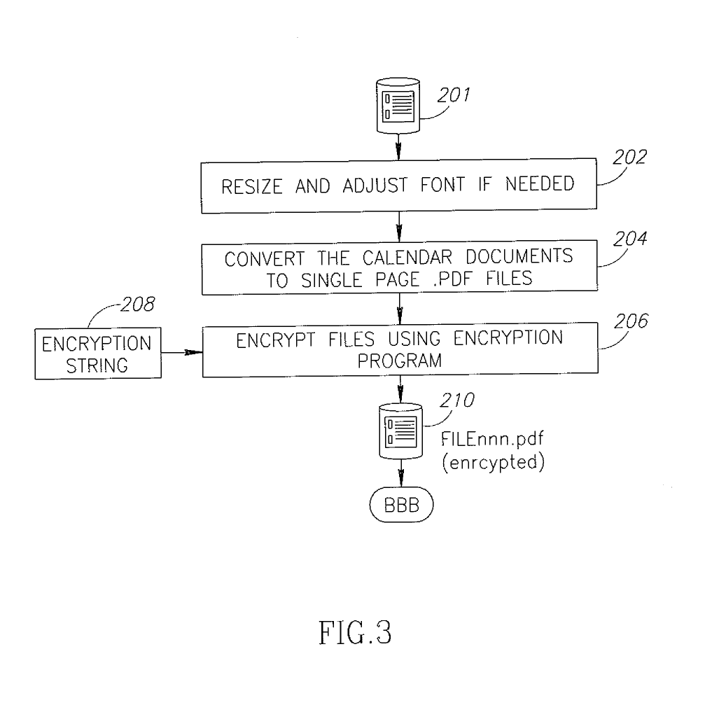

FIG. 3 is a flow diagram detailing a process for creating electronic data, such as creating electronic calendar pages. The pages are typically representative of a day, but could also be representative of other time intervals, such single and multiple days, weeks, months, or other time divisions, or combinations thereof. At block 202, each paper page 201 is resized and adjusted using a software program such as Quark®, from Quark, Inc., Denver Colo. 80203. The process moves to block 204, where each adjusted page is converted to a single page in a separate file, for example in portable document format (PDF). This is performed using a program such as Photoshop® from Adobe®. Each electronic page, now a file, is then encrypted, at block 206. Encryption typically involves applying an encryption string at block 208 to the file to be encrypted.

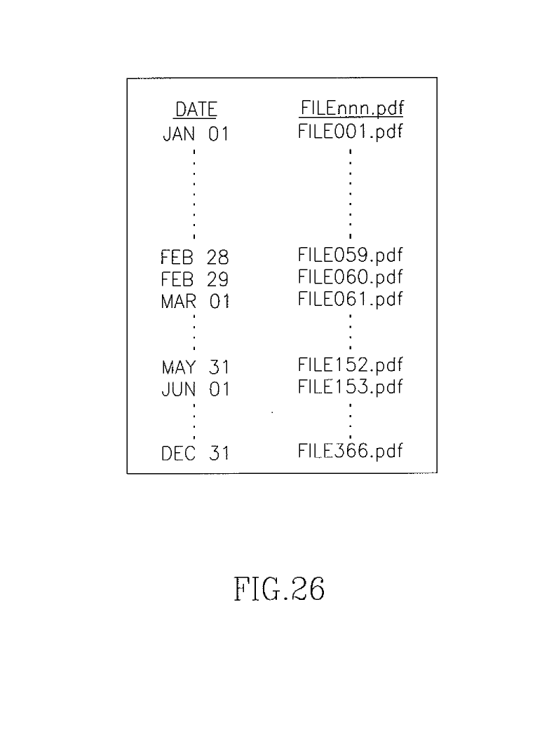

Encryption may be performed with software, for example, net encryption from Microsoft of Redmond Washington, or wodCrypt™ from WeOnlyDo! Software of Osijek HR-31000, Croatia (www.weonlydo.com). An entire calendar, for a predetermined time period, for example, one year, formed of, for example, 366 files, one file for each day including a day for February 29, to accommodate a leap year, as illustrated by the table of FIG. 26, is now complete. Alternately, there may be fewer than 365 files as some files may cover two or more days such as weekends or holidays resulting in a single calendar page for such weekends and holidays. Each of the encrypted files is a calendar page file 210 (also sometimes referred to as a calendar page), this calendar page file 210 formed of data and representative of the files that form the calendar and the resulting calendar pages displayed in the calendar forms 550, as detailed below (as the data is ultimately converted into an image of the calendar page, as detailed below, viewable on a computer monitor, screen or the like).

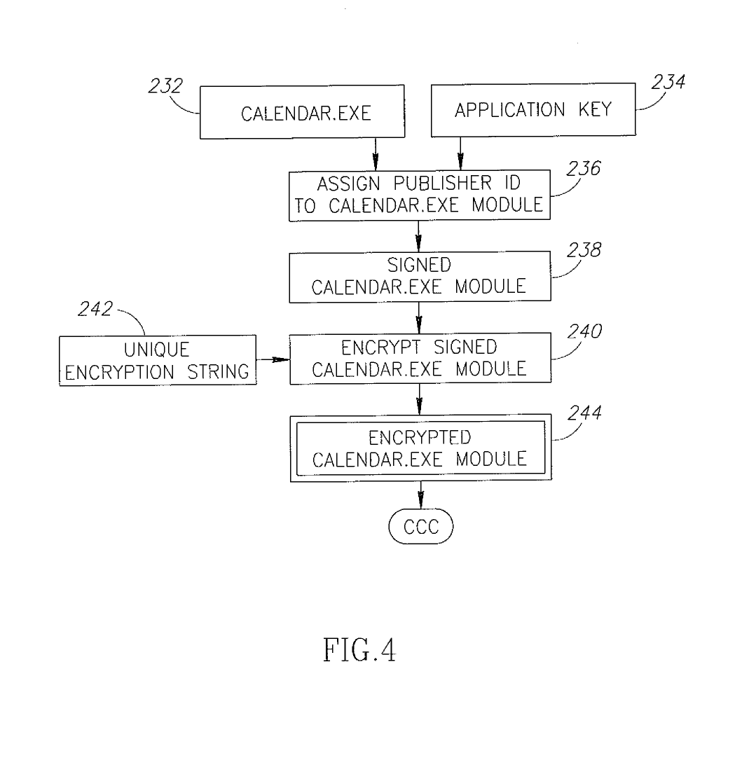

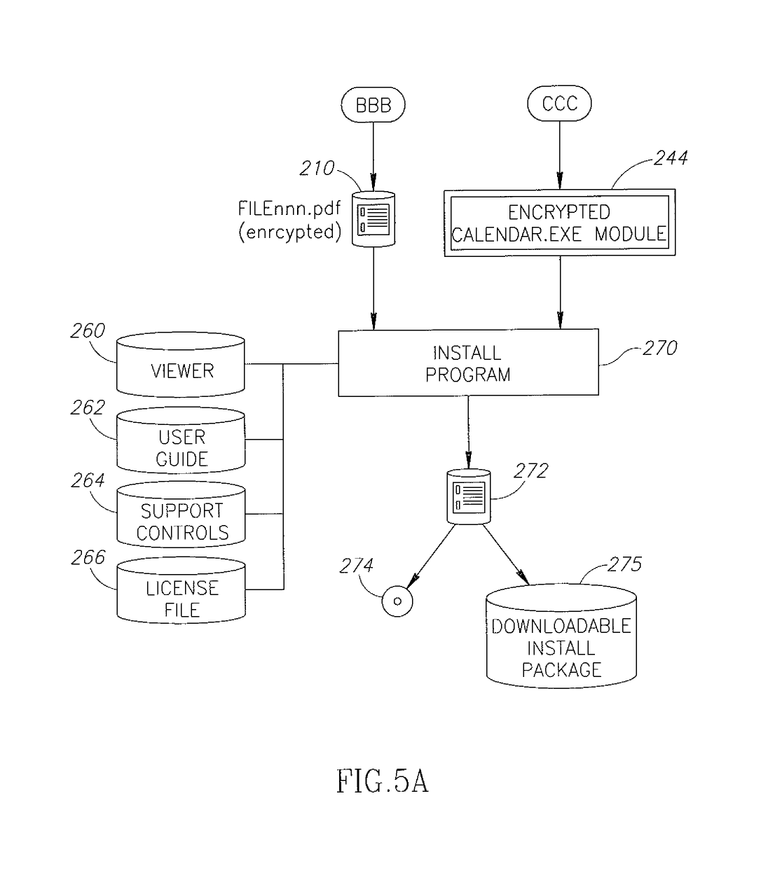

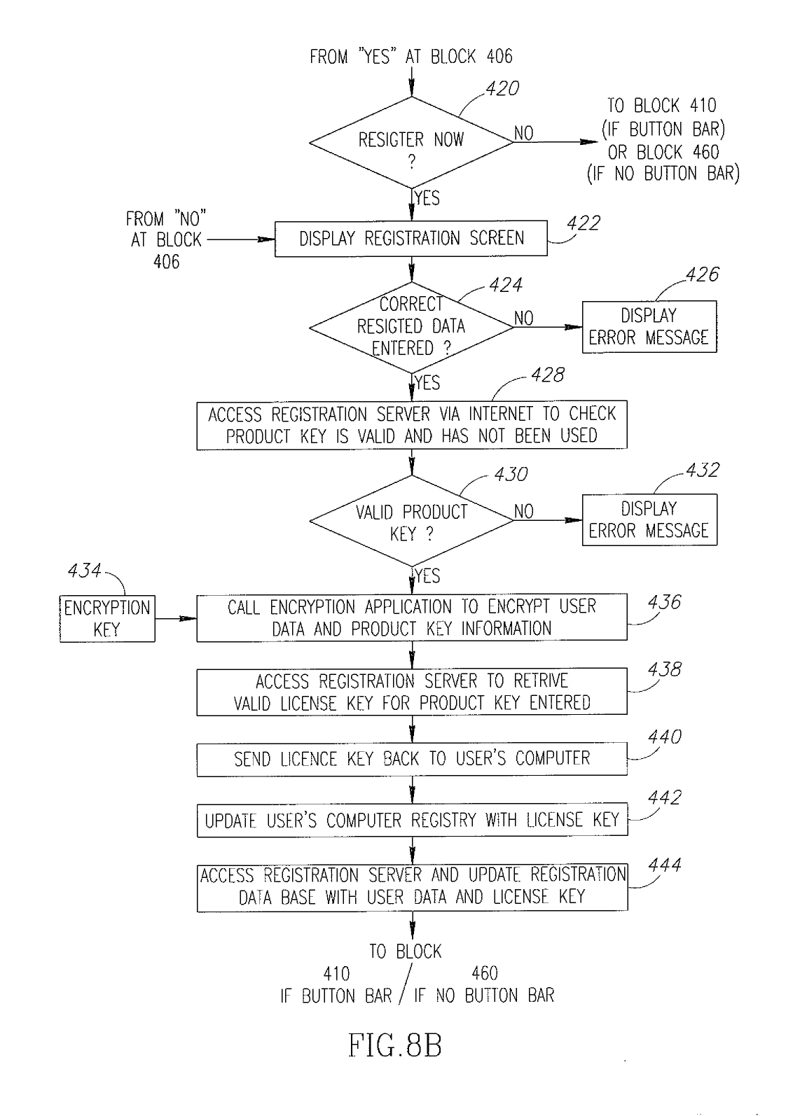

FIG. 4 is a flow diagram detailing a process where the application is signed and encrypted. Initially, at block 232, a module to run each calendar is provided, typically as a “.exe” module, for example, for an electronic calendar, and is accordingly referred to as “calendar.exe.” A “.exe” module includes an executable program in the OpenVMS, DOS, Microsoft® Windows® and OS/2 operating systems. The calendar.exe module typically includes multiple applications, for example, those for obtaining the date from the computer's operating system, obtaining, for example, by accessing and pulling, the requisite files for the calendar pages corresponding to the obtained date, creating and displaying the form in which the calendar pages (from calendar page files) are displayed (as images), creating overlay boxes for displaying dates and other information, that lie over the displayed calendar page, interfacing with other calendaring and time-based functions and applications, and scripts for creating and sending e-mail and text messages to wireless devices, such as cellular telephones, personal digital assistants, smart phones, Blackberry® devices, and the like. Operation of the calendar.exe module, is shown in FIGS. 8A and 8B and described with reference to these drawing figures below.

There is also an application key, at block 234, for example, a registration key from Verisign® of Mountain View, Calif. Both the application key and the .exe module are input into an application that assigns a publisher identification (ID) to the .exe module, at block 236, using a program, for example, such as sign.exe from Microsoft. A signed module (calendar.exe) is created at block 238 (the output of block 236). At block 240, the signed module from block 238 is encrypted by being read into the encryption application, such as EXECryptor (SoftComplete Development, Vancouver, BC) or .net encryption (Microsoft), along with a unique encryption string, from block 242, to create a signed and encrypted application module (calendar.exe) in block 244.

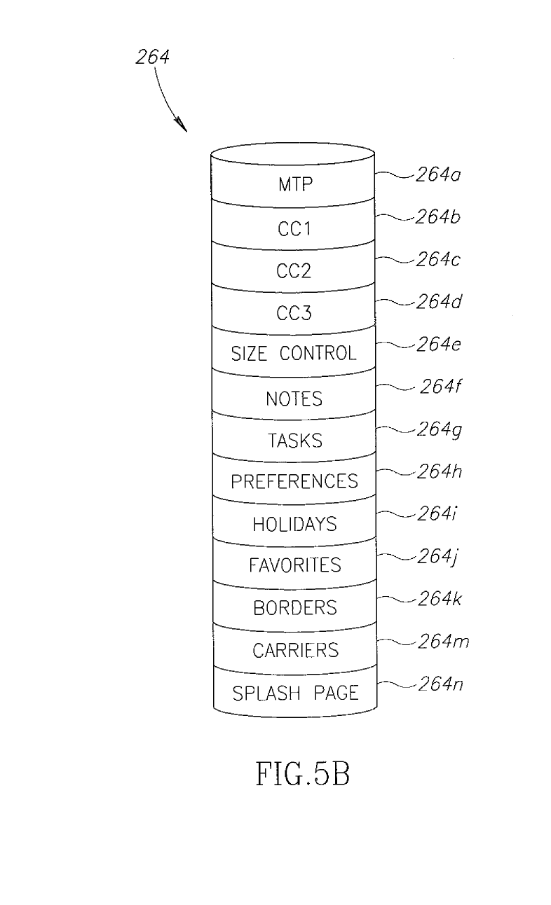

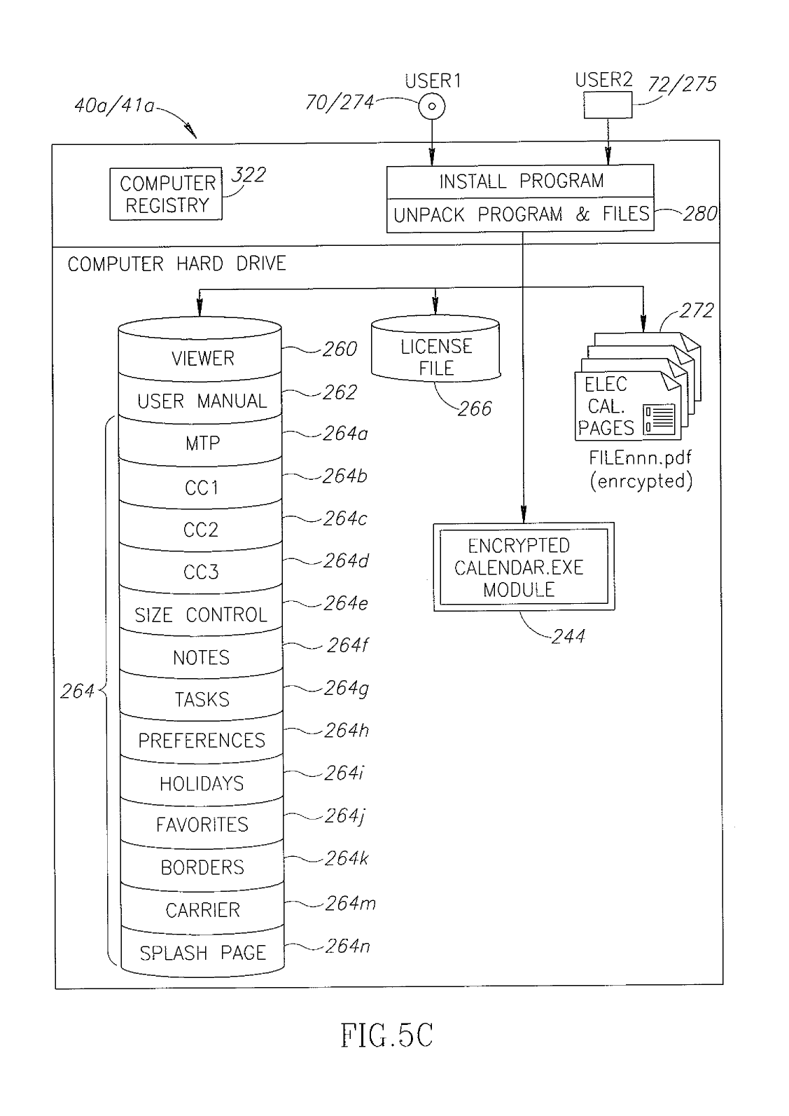

In FIG. 5A, there is shown a flow diagram of the package application and calendar pages for distribution. Initially, the calendar formed of encrypted calendar page files 210 and the signed and encrypted module 244 are packaged with applications, programs and components 260, 262, 264, and a license file 266, at block 270. While three applications and components are shown, this is exemplary of the numerous applications and components that are permissible with the electronic calendars of the disclosed subject matter. The packaging is for example, with an install application, for example, installation software for a Windows®, Mac®, OS/2 or other similar computer operating system, such as, InstallShield, from Macrovision, Santa Clara, Calif. 95050.

The first application 260, is, for example, a viewing application, to allow for viewing of a calendar page on the monitor or other computer screen display. Specifically, this application reads the PDF files for the calendar pages, and converts the data into images for screen display, as shown, for example in FIG. 11. This application may be, for example, XPDFViewer™ from Glyph & Cog, LLC of Cupertino, Calif. (www.glyphandcog.com).

A component includes a user guide 262. This user guide 262 is typically an instruction manual in PDF format, and allows users to review this document or parts thereof for how to use and operate the electronic calendar and troubleshoot if necessary. It may also provide technical specifications and other information associated with the electronic calendar.

Additional support controls and files to support the applications for the calendar 264 are also part of the package application. Support controls include, for example, visual basic or net (Microsoft), for example .net 1.1 Framework (a set of libraries/controls that provide various functions utilized by the application), controls that allow for operation of the application. These controls may be for example, dynamic link library (dll) files, and/or net (Microsoft) framework. Dll files are typically used as they interface with various known programs and applications. Exemplary dll files include those that interface to Outlook® components for calendaring and time-based functions, such as appointments, to do lists, task lists, reminders, and applications for wireless communications.

For example, as shown in FIG. 5B, support controls and files that define the support controls 264 may include a mail transfer protocol software (MTP) 264a, that allows for the sending of e-mail and text messages, for example, ANSMTP, from AdminSystem Software, Ltd. of Causeway Bay, Hong Kong (www.emailarchitect.com). There is also a calendar component (CC1) 264b for scrolling between months, such as dbicalendar™ from DBI Technologies, Inc. of Winnipeg, Manitoba (www.dbi-tech.com), a second calendar component (CC2) 264c that provides a view of a month as broken into days, weeks or the like, for example, dbiMonth™ from DBI Technologies, Inc. of Winnipeg, Manitoba, and a third calendar component (CC3) 264d, that provides a view of an individual day or days, for example, dbiDayView™ from DBI Technologies, Inc. of Winnipeg, Manitoba.

There is also a size control application 264e, that is used to size and scale the application window on a user's computer, for example, C1 Sizer, from ComponentOne of Pittsburgh, Pa. (www.componentone.com). There is a notes file 264f, to hold various notes entered by the user, as well as a tasks file 264g, to hold various tasks entered by the user. There is a preferences file 264h, to hold a set of parameters that are used to set or control various functions of the application, and a holidays file 264i, that is a text list of holidays for display in the overlay box 556 of the calendar page 554 (for example, as shown in FIG. 11), and a favorites file 264j, used to hold a list of calendar pages that a user selects and notes as favorites, to be saved. The aforementioned files 264e, 264f, 264g, 264h, 264i and 264j may be, for example, either a text (.txt) or Extensible Markup Language (XML) file.

There is also a file 264k to create a border or “skin” 556a-556d around the calendar form 550 (FIG. 11), and that provides a constant visual look for each calendar. An exemplary border or “skin” creating file is SkinCrafter from DM Soft Technologies of Bishkek, Kyrgyzstan (www.skincrafter.com and www.dmsofttech.com). There is also a file 264m labeled “carriers”, that includes e-mail domains/addresses for various wireless carriers (e.g., Sprint®, Verizon®, AT&T®, AllTel®, T-Mobile®, etc.). This file 264m, may be a text file (.txt). There is also a splash page file 264n, that places a splash page into a calendar form 550, when the calendar is expired or finished, as detailed below.

The license file 266 is a separate file for each calendar or other data ordered or subscribed to. The license file 266 includes a start and end date for the requisite calendar or other data, for displaying the calendar page files. The license file is, for example, a .lic file, and indicates the specific calendar that the user has, along with when that user's access to the calendar begins and ends.

With the install application applied to the packaging operation at block 270(FIG. 5A), the electronic calendar is in a format for distribution 272. Exemplary formats for distribution include media such as compact discs (CDs) 274, digital versatile discs (DVDs), etc. and downloadable install packages 275, for distribution through servers, for example, the data server 32b, over networks, such as the Internet 24.

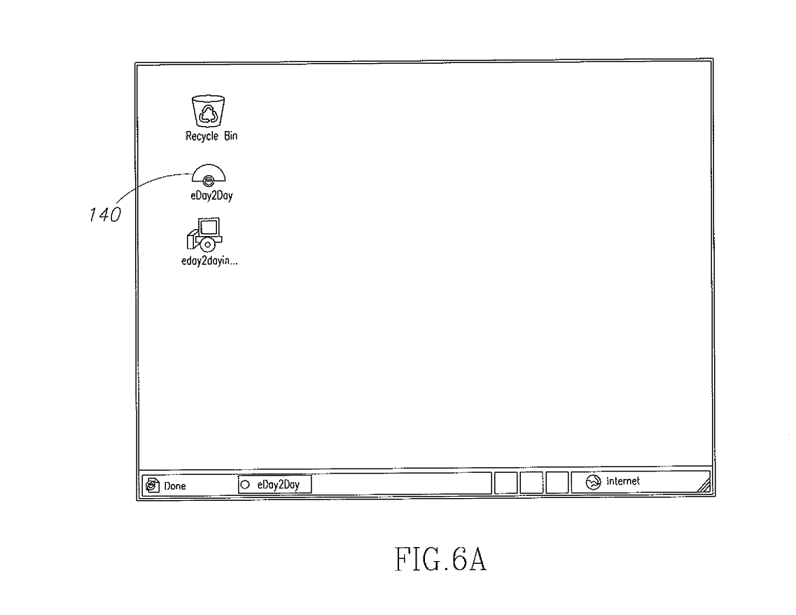

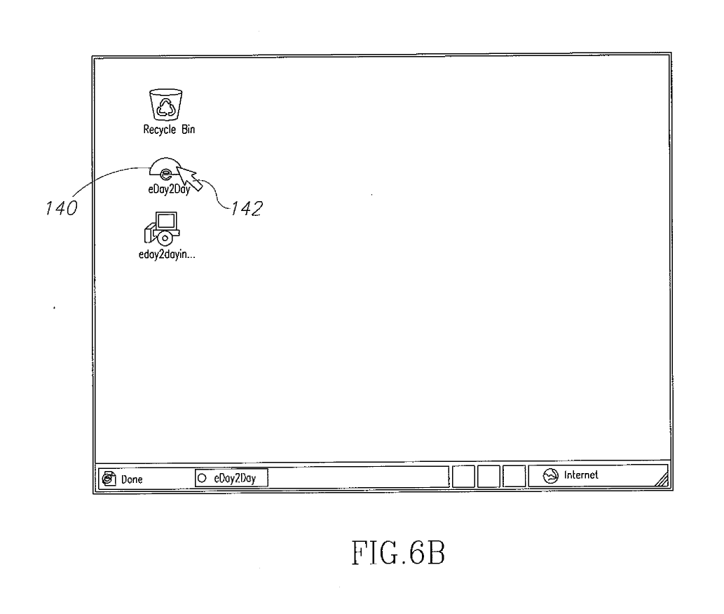

FIG. 5C shows the install process. Prior to this process beginning, the files for the calendar and supporting applications, programs, controls, components, and files (260, 262, 264 from FIG. 5A) and an install application, as packaged into a disc 70/274 or a downloadable install package 72/275, are loaded or downloaded onto the users computer (for example, on the hard drive). The install process occurs at block 280, as all applications and components 260, 262, 264 and the license file 266, encrypted module for the calendar.exe program 244 and PDF formatted calendar pages 272 (FIG. 5A), and install application, are unpacked and loaded onto the hard drive of the computer 40a (from a disc 70/274) 41 a (from a downloadable install package 72/275) of the respective exemplary user (User1 40 and User2 41), and the install application is activated. The install application may be, for example, InstallShield. Once the calendar application has been installed, an icon 140 appears on the screen of the user, as shown in the screen shot of FIG. 6A.

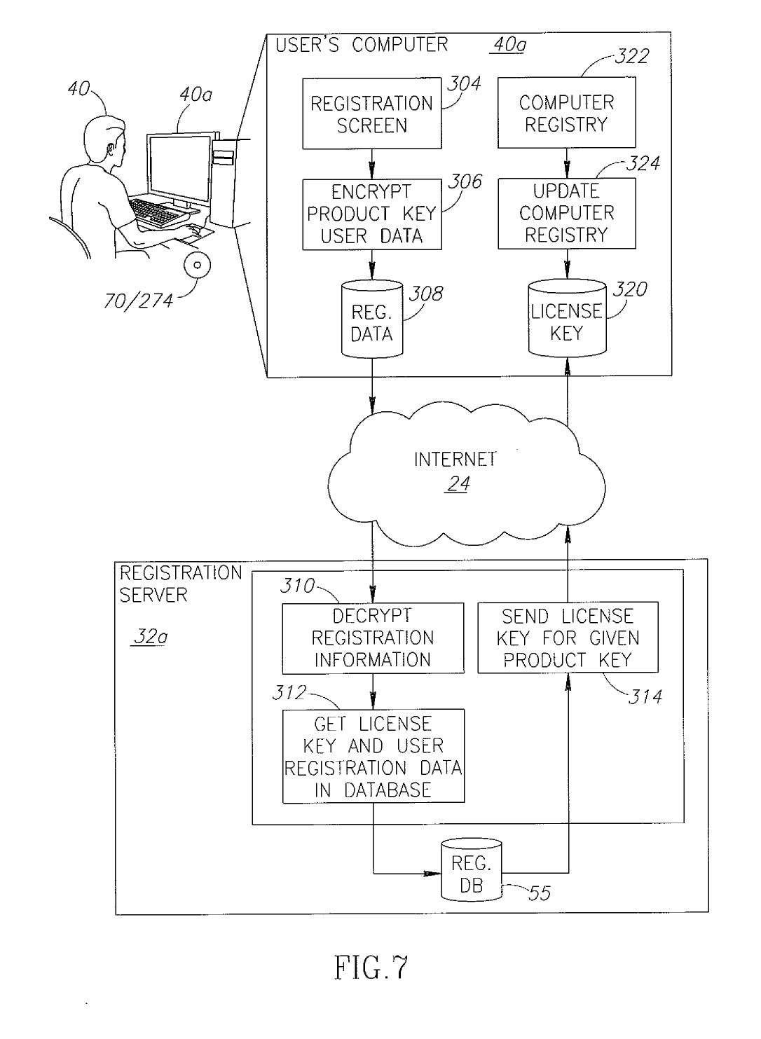

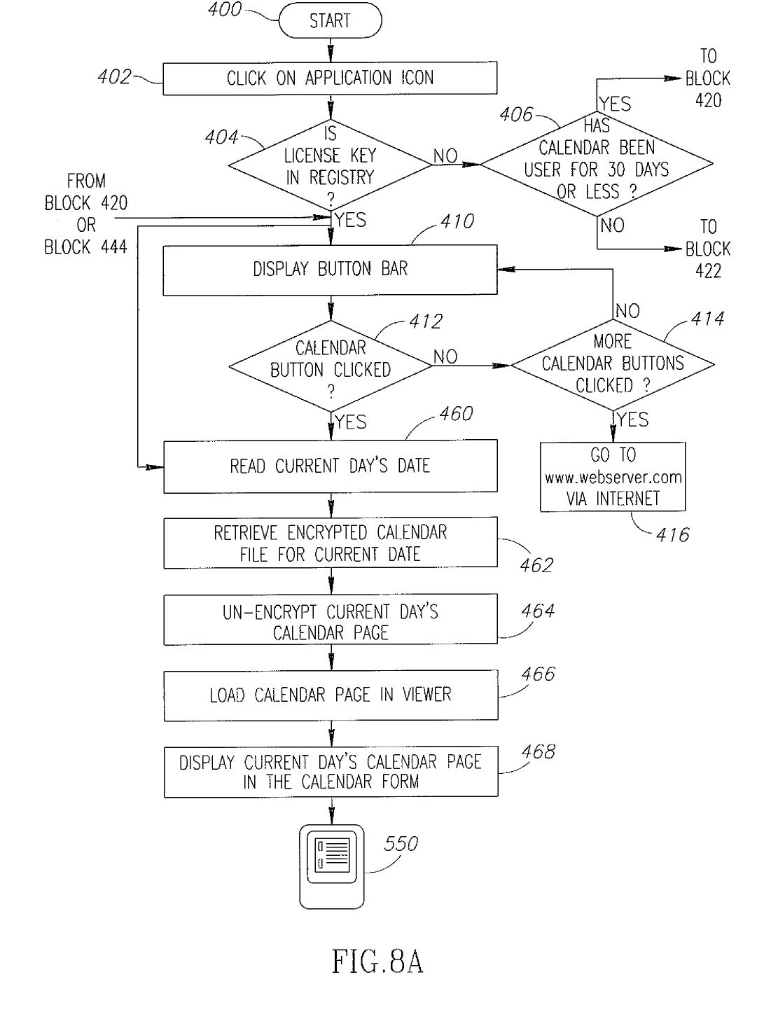

FIG. 7 shows a diagram of the interaction between the registration server 32a and a user's computer, representative of the registration process for all users and their computers or other computer-type machines. For example, the computer 40a of user1 is discussed in this exemplary process. The computer 40a initially receives the application in an encrypted form, for example, such as a CD 70/274, downloadable install package 72/275, or other type of file. The user 40 sees a registration screen 304, as a screen display on his monitor and enters registration data, such as product codes and other data, typically received with the product (in the package for the CD and sent in a separate e-mail if downloaded), in the appropriate portion of the registration screen 304. The data entered at the registration screen 304 is encrypted at block 306, and is known as the registration data 308. The encrypted registration data 308 is sent to the registration server 32a, where it is decrypted, at block 310. The license key 320 and user registration data is obtained from the sent data, at block 312, and stored in the registration database 55.

The registration server 32a then sends a license key 320, corresponding to the product key, now in the registration database 55, to the user's computer 40a, at block 314. The license key 320 is, for example, a registry key that is designed to be updated. The license key 320 is received in the user's computer 40a. The computer registry 322 is updated with this license key 320, at block 324. The electronic data is now registered on the user's computer 40a.

Attention is now directed to FIGS. 8A and 8B, that form a flow diagram for running the application for the electronic data, for example, the electronic calendar, also shown as “calendar.exe” in FIGS. 4 and 5A-5C above. Prior to this application, the data for the calendar has either been installed, for example, if from media, such as a CD, or downloaded and installed, if from a downloadable install package in a server, such as the data server 32b, as detailed in FIG. 5C above.

The application begins with the START block 400. The user then “clicks” on the icon 140 (FIG. 6B) for the electronic calendar application (the “click” shown by the arrow 142 in FIG. 6B) at block 402. Within the exemplary user's computer 40a, the registry 322 (FIG. 7) is checked for the license key, at block 404. If the license key is in the registry 322, the process moves to block 410, where a display button bar 502 with buttons 504, 505 for the subscribed calendars (button 504 for a OLD YORKER themed calendar and button 505 for another themed calendar known as “C2”) or 506 for more calendars (if the user wishes to see more calendars for purchase), appears on the screen of the user, as shown in FIG. 9A.

The process moves to block 412, where it is determined if a calendar button, for example buttons 504, 505, have been activated or clicked, by, for example, a click of a pointing device or mouse. If a calendar button 504, 505 has not been clicked, the process moves to block 414, where it is checked if the “more calendars” button has been clicked. If not, the process returns to block 410, and if yes, the browser of the user is directed to a web site for ordering calendars, for example, the web server 36 with its URL of www.webserver.com, at block 416. For example, once at the web site of the URL of www.webserver.com, the user will see a screen display like that of FIG. 2A, to order additional calendars on-line, over the network.

Returning to block 412, if a calendar button 504, 505 was clicked (the click shown by the arrow 507 in FIG. 9B), the process moves to block 460. Alternately, referring to block 404, if a license key is in the computer registry 322 and if there is only a single calendar (and the computer is programmed not to show a display button bar), the “clicked” icon 140 (FIG. 6B) is such that the process moves directly, from block 404 to block 460, bypassing blocks 410 and 412.

Returning to block 404, if a license key is not in the computer registry, the process moves to block 406, where it is determined if the calendar has been in use for a predetermined time period, for example, 30 days or less. The detection of the 30 days or less is done by an application (for example, code inside the calendar.exe module) or module inside the user's computer, that checks the install or other first date from the license file 266 for the requisite calendar, and compares it with a date read from the operating system of the user's computer. If the comparison indicates a difference of 30 days or less, the calendar has been in use for 30 days or less, and the process moves to block 420, where the user is prompted to register the calendar. This process occurs each time the user accesses the calendar until the calendar is registered.

At block 420, and making reference to FIG. 5B, the user is prompted to register the calendar (or other electronic data). If the user decides not to register the calendar, the process moves to block 410, or alternately block 460, depending if the calendar application uses a button bar 502, as detailed above. If the user decides to register, a registration screen is displayed on their computer, at block 422. A display registration screen, for the user to provide registration data, appears on the monitor or other computer screen of the user.

Returning to block 406, if the comparison indicates more than 30 days, the calendar has been in use for greater than thirty days, and the process moves to block 422. At block 422, the user is requested (prompted) to register the calendar, and a display registration screen, for the user to provide registration data appears on the monitor or other computer screen of the user.

Resuming at block 422, registration data to be entered includes, for example, product data, such as codes, registration numbers, typically from the packaging or part of a separate e-mail sent once a download is complete. At block 424, the registration server 32a checks to see proper and correct registration data has been entered. If improper or incorrect data is entered, the user receives an error message, at block 426. If proper and correct registration data has been entered, the process moves to block 428. Alternately, for example, a splash page (detailed below) or other indicator that he can no longer use the calendar, unless the user properly registers the calendar with correct registration data, will be displayed. If correct registration data is entered at block 424, the process moves to block 428.

At block 428, the registration server 32a is accessed over the Internet 24 to check that the product key is valid and has not been used. The product key is then checked for validity, at block 430. If the product key is invalid, the registration server 32a sends an error message, at block 432. If the product key is valid, an encryption application, such as wodCrypt or .net encryption (Microsoft) is called up (from an encryption key 434), to encrypt the received user data and the product key information, at block 436.

Access is then granted to the registration server 32a, to retrieve a valid license key for the product key that was entered by the user, and transmitted over the Internet to the registration server 32a, at block 438. The registration server 32a then sends the license key back to the computer of the user, over, for example, the Internet 24, at block 440. The registry 322 in the computer 40a of the user 40 is now updated with the license key, at block 442. The registration data base 55, residing on the registration server 32a is now updated with the user data and the license key, at block 444.

From block 444, the process returns to block 410, or alternately, block 460, depending if the calendar application uses a button bar 502, as detailed above.

From block 460, the user's computer reads the current day's date from its operating system. The computer then retrieves the previously downloaded and encrypted calendar file for the current date, at block 462. From the stored application, the decryption application stored with the calendar files is accessed (called), to decrypt the calendar page for the requisite day, at block 464. The now decrypted calendar page is loaded into a viewer, at block 466, for example, XPDFViewer™, and the current calendar page 554 is displayed in the calendar form 550 on the screen of the user's computer, at block 468.

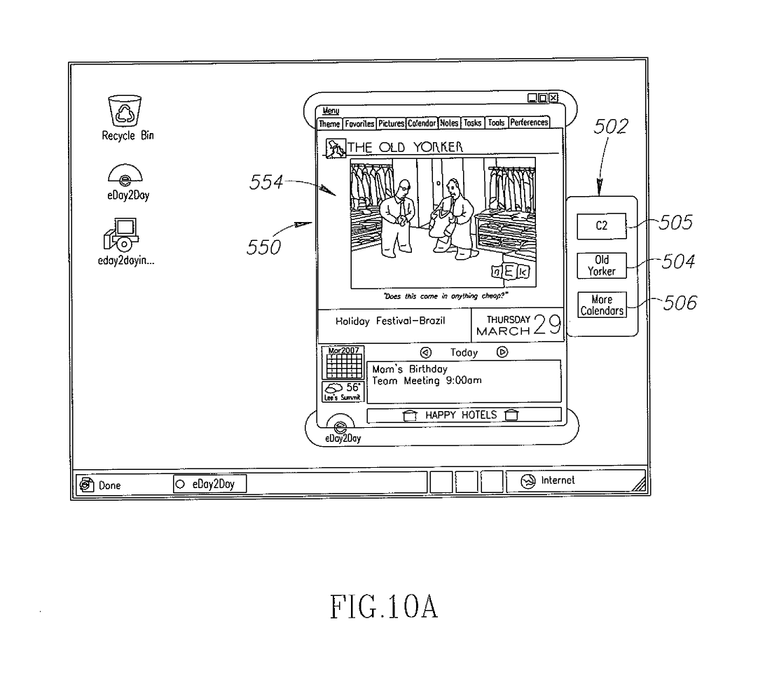

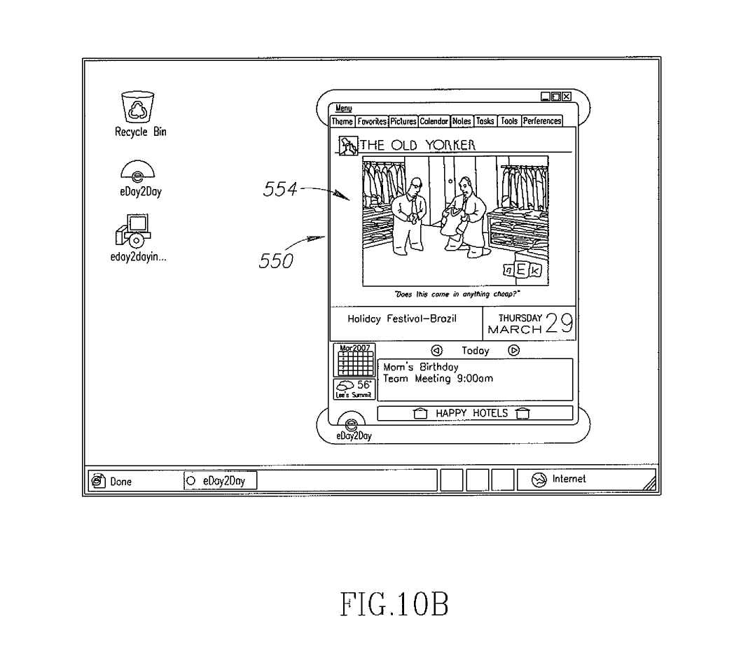

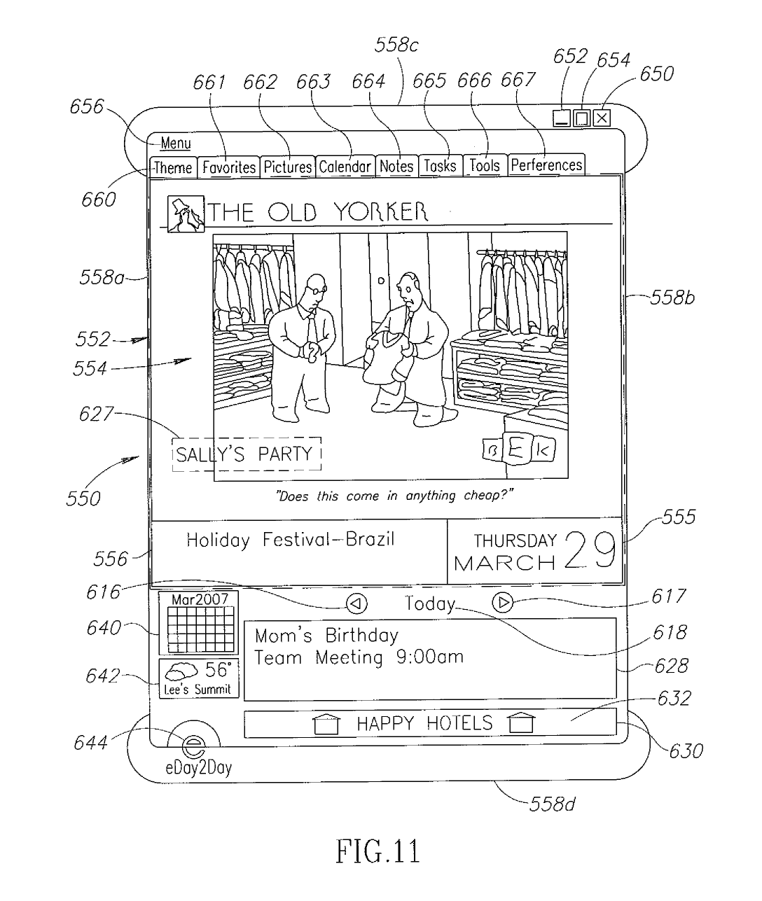

The calendar page 554 in the calendar form 550 is now displayed on the screen of the user's computer, as shown, for example, in FIG. 10A, if activated from a button bar 502, or FIG. 10B, if activated directly upon activating the icon 140. Alternately, a screen supporting the calendar form 550 when activated from the button bar can look like the screen of FIG. 10B, if the button bar 502 is programmed to disappear or be hidden upon activation of the calendar form 550. The calendar form 550 is representative of all calendar forms 550 with calendar pages 554, to be displayed on the screen of a user, with functions of the calendar form 550 now detailed below.

Once the calendar has been installed and registered, the remainder of the operation, until the end of the time period for the calendar, in particular, the downloaded files corresponding to the calendar pages for the dates corresponding to the time period for the calendar, is shown, for example, with reference to FIGS. 6A, 6B, 9A, 9B, 10A and 10B. Once the calendar application has been installed, an icon 140 appears on the screen of the user, as shown in the screen shot of FIG. 6A.

When this icon 140 is activated, by a click of a mouse 142 or other pointing device, as shown in FIG. 6B, a button bar 502, as shown in FIG. 9A, appears on the screen of the user. If a calendar is desired, for example, the OLD YORKER themed calendar, button 504 is “clicked” as shown by the click of arrow 507 in FIG. 9B, and the calendar page 554 appears in a calendar form 550 in FIG. 10A, with the button bar 502 on the screen of the user.

Turning back to FIG. 9A, should the “more calendars” button 506 be clicked or activated, an underlying link is activated, directing the user's browser or browsing application to the web server 36, of the of URL www.webserver.com, in order that the user may order more calendars. The user would now see the screen shot of FIG. 2A on his computer screen, a web page hosted by the web server 36, where more calendars or other electronic data items can be ordered (as detailed above).

Attention is now directed back to FIG. 6A. Alternately, the installed calendar and supporting programs and applications may be programmed such that the button bar 502 is eliminated. Instead, when the icon 140 is clicked, as shown in FIG. 6B, the calendar form 550 with the calendar page 554 for the date as read from the computer's operating system will appear directly on the monitor or other screen display of the user's computer, as shown in FIG. 10B.

For each calendar, the requisite calendar page 554 or segment, as it is time based, typically to the day (or days), may also be automatically activated, and read into (placed in) the form 550, once the user activates his computer for the first time during a day. This activation may be, for example, by initially clicking on the icon 140 for the calendar on the computer screen, as shown in FIG. 6B, and ending with the process of obtaining the calendar page 554 in the calendar form 550 on screen, as shown in FIGS. 10A and 10B. Additionally, upon this activation, the requisite scheduling information or calendar of the user may be pulled from the user's calendaring/scheduling application, such as Microsoft® Outlook® or iCal™ from Apple®, such that it appears in the calendar form 550 (in a box or other portion) or built-in calendar 640 or tab 663, as detailed below.

FIG. 11 shows an electronic calendar form 550, that is stored in the calendar.exe module, as detailed above. The form 550 includes an area 552 (shown in this drawing figure in a broken line box), into which an electronic calendar page file 210 is read into and displayed as a calendar page 554. The calendar page file 210, that is read into the area 552 corresponds to the date that is read in from the computer operating system (of the user's computer). The calendar page files 210, that are read into the area 552 of the form 550, are, for example, from a set of files, such as that of FIG. 26, where each file corresponds to a specific date.

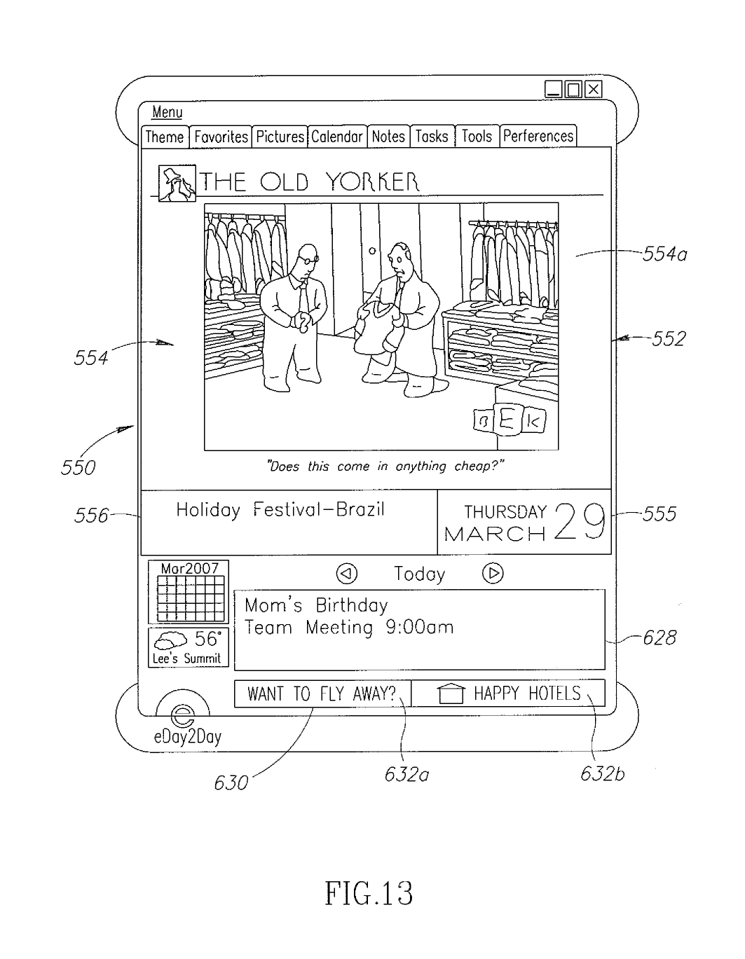

The displayed calendar page 554 includes, for example, an image 554a(FIG. 13). Overlay boxes 555, 556 may lie over the displayed calendar page 554, typically within the area 552. Overlay box 555, for example, displays date information, such as the date read in from the computer's operating system, while overlay box 556, for example, displays information such as holidays, from the holiday file 264i, for the read-in date. There is also an outer skin or border 558a, 558b, 558c, 558d, along each side (edge) of the area 552 (formed by the Borders file 264k), that can be grabbed by a mouse activation, and moved, to change the scale or size of the calendar form 550, in accordance with the sizing control file 264e.

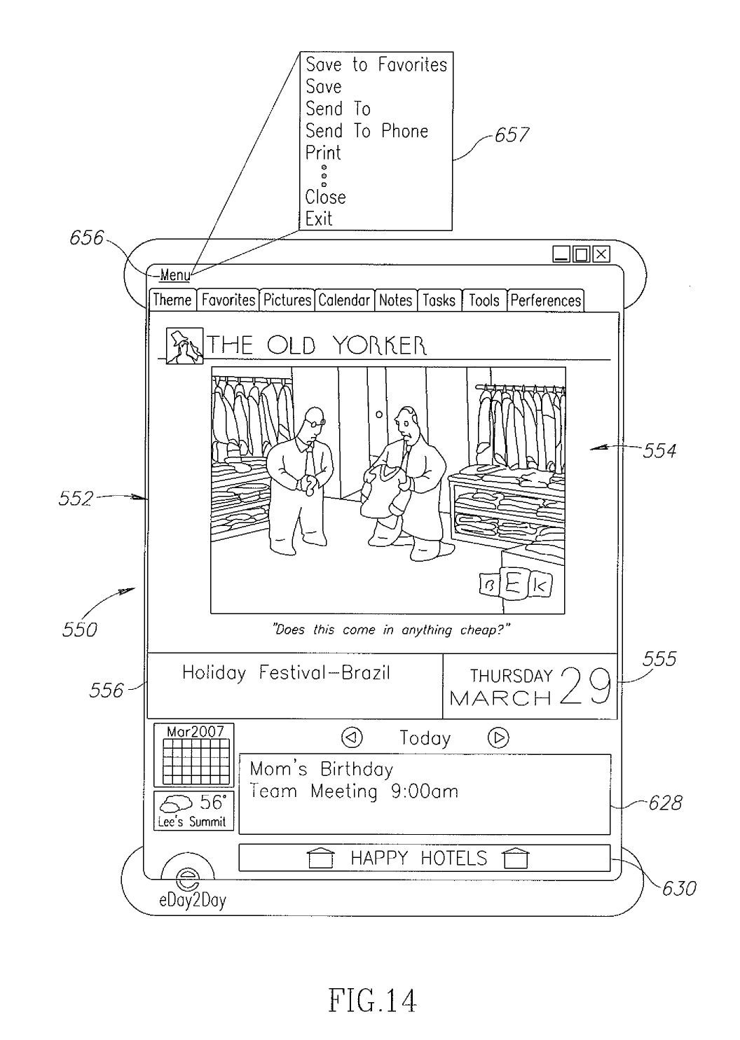

The form 550 includes activatable buttons 616, 617 for obtaining the calendar page from a day earlier, or the next day, respectively. There is also a button 618, that when clicked, will display the current date's (day's) calendar page 554 in the form 550. A special message, shown in the broken line box 627, may be placed over the displayed calendar page 554. This message may be deleted by the user, by a click or the like, may be is added as a preference (associated with the preferences file 264h) and is discussed with reference to FIG. 21 below. At another location on the calendar form 550, at box 628 (also known as a text box), there is an area where appointments, meetings, reminders, or the like may be imported from a calendar or schedule application, for example Microsoft® Outlook®. Moreover, the electronic calendar of the disclosed subject matter includes software and other applications for integrating applications such as Microsoft® Outlook®, and the like, and to perform functions such as those shown by the screen shots of in FIGS. 14-23 and detailed below.

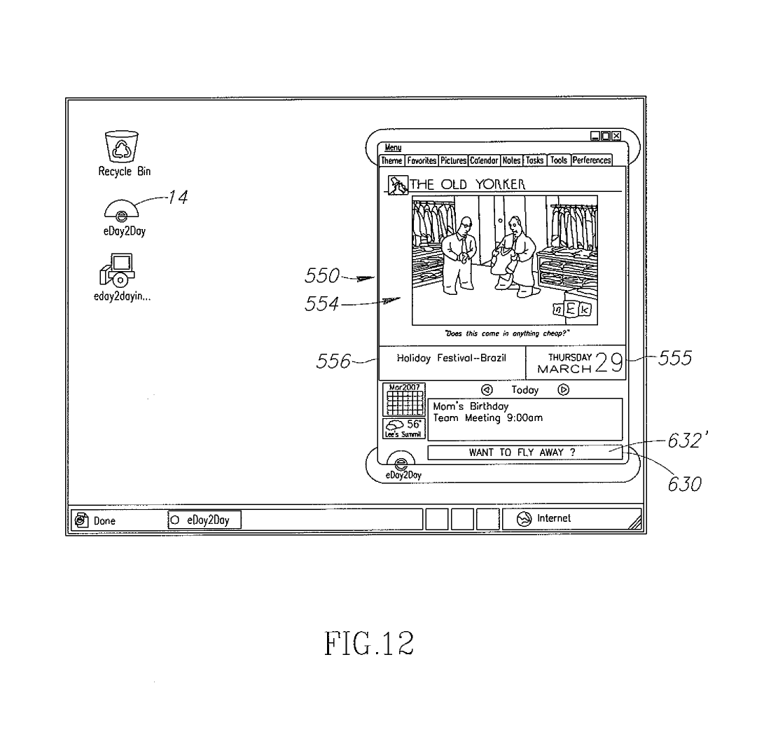

There is typically also a box 630 in the form 550 for one or more billboards, for example, a billboard 632 (the billboard, for “Happy Hotels”) or the like. Box 630 can accommodate a single billboard, rotating billboards, or multiple billboards 632a of FIG. 12, either horizontally or vertically arranged, or combinations thereof. The billboards may be preprogrammed into each calendar form 550, or filled and/or rotated, each time the calendar is activated and presently active on-screen (or the user's computer is operating and on-line), as the calendar applications automatically open and maintain a connection or pipe to the media server 34 or other server, over the network, such as the Internet 24. The media server 34 typically controls the maintenance of the billboard boxes 630, by filling it with billboards, and/or rotating the billboards.

Each billboard typically covers a link, that when activated, by a mouse “click” or the like, will direct the browser of the user, either directly to the targeted web site associated with the billboard, or another server, for example, the media server 34, where the browser or browsing application is redirected to a target web site. For example, from FIG. 11, the targeted web site for the billboard 632 for “Happy Hotels” maybe hosted by one of the third party servers 48a, 48b of FIG. 1, and promoted directly by Happy Hotels or a party associated therewith.

Also, for example, in FIG. 12, the billboard “Want to Fly Away?” 632′ may cover a link to the media server 34. The media server 34 may rotate travel sites, such as on a paid basis for various advertisers, so that at a first time, a click on this billboard first directs the user's browsing application to the media server and then to the presently active redirect, for example, Airline A's web site (hosted for example, by a third party server 48a, 48b), and at a second time, after the first time, a click on this billboard first directs the user's browsing application to the media server and then to, the presently active redirect, Airline B's web site (hosted for example, by a third party server 48a, 48b). Two or more billboards 632a (corresponding to billboard 632∝), 632b (corresponding to billboard 632) may also be in the same billboard box 630, as shown in FIG. 13, with the covered links as detailed above.

Alternately, this area of the box 630 may also support an application, such as a media player, or a combination of billboards and applications.

Turning back to FIG. 11, the calendar form 550 also includes buttons covering a control 640, as well as built-in or embedded links 642, 644. The control 640 may be, for example, a calendar that when activated will enlarge to show the current month in a calendar format, as well as dates that when clicked will show the calendar page for that day in a form 550 if available. The control 640 is part of a package of files (for example, CC1-dbiCalendar™ 264b) placed onto the hard drive of the user's computer during install of FIG. 5C, as detailed above.

Button 642 may be a direct link to a web site in a third party server 48a, 48b for weather. It may also cover a link to the media server 34, which will then redirect the user's browser to a web site for weather, as selected by the party controlling the media server 34. This button can rotate and can be for numerous other information such as news, traffic, etc. Button 644 may cover a direct link to the web server, www.webserver.com, that will redirect the users browser to the web site, such as that shown in FIG. 2A, from where they can order more calendars, renew their present calendar, or order other media items, as detailed above. The calendar form 550 may also include locations that will support buttons for other functionalities, such as clocks, calculators, etc., and other links to targeted web pages (or web sites).

The calendar form 550 also includes controls, close 650, reduce 652 and enlarge 654. There is also a menu bar 656, that when clicked, produces a drop down menu 657, with options, shown in FIG. 14 and detailed below. There are tabs 660-667, that when clicked will show items for various functionalities. With the items associated with tabs 661-667, each item is typically displayed in the area 552 of the form 550, that supports the calendar page 554.

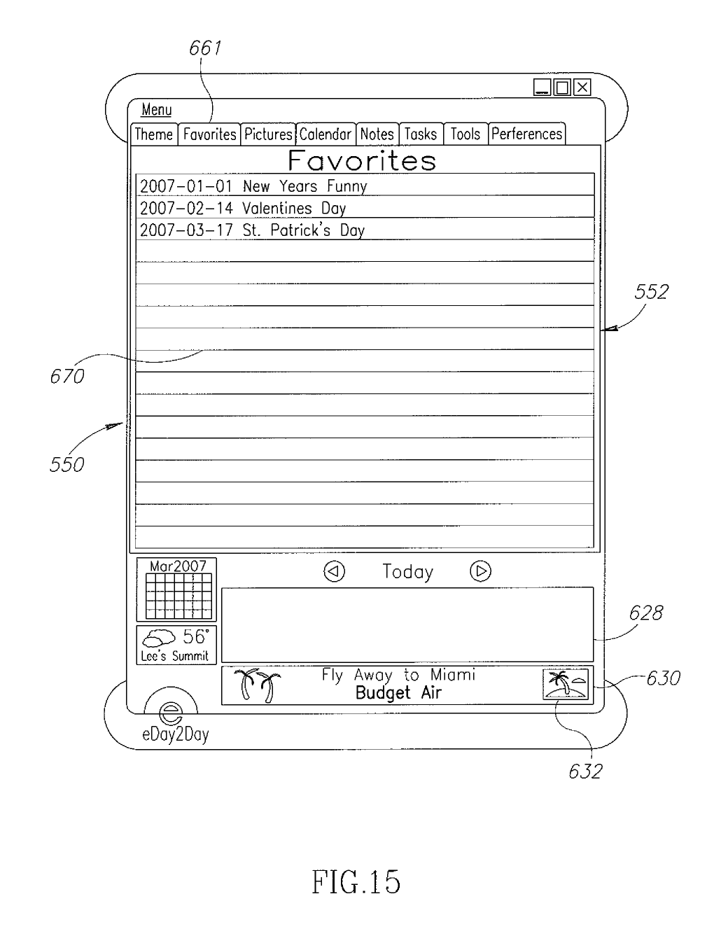

Turning to FIG. 14, the drop down menu 657 is shown. The options for this drop down menu 657 include, for example, functions for saving, such as “Save To Favorites”, where, the calendar page will automatically be saved to Favorites (tab 661 and FIG. 15), as per the control 264j of FIGS. 5A-5C and detailed above), “Save”, “Send To”, to send to e-mail addresses, “Send To Phone”, to send to mobile phones and other wireless devices as text messages, e-mails, or other electronic communications, “Print”, to print the desired electronic item or that which is displayed on screen, “Close”, to close the menu (and return to the previous screen), and “Exit”, to exit the requisite program or session. The menu options are typically linked with programs for running the requisite applications.

As shown in FIG. 11, tab 660, when activated, displays the calendar page 554 in the form 550. This theme tab 660 is typically the initial setting or default setting, and when the calendar is activated, the calendar page 554 is displayed in the form 550.

Tab 661 is for Favorites, where a user can mark and store favorite calendar pages 554, in a Favorites list 670, as shown in FIG. 15. The Favorites list 670 replaces the calendar page 554 in the area 552 of the form 550. When a list item is clicked, the stored image or calendar page is pulled up and displayed on-screen. This is similar to keeping a torn-off page from a paper calendar, after its date has passed.

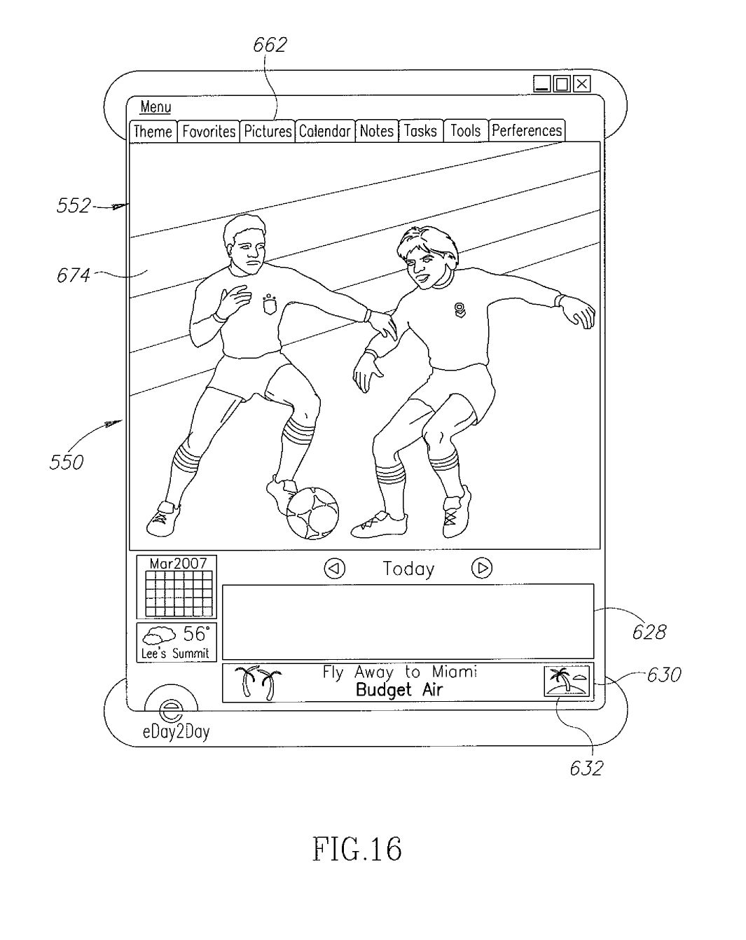

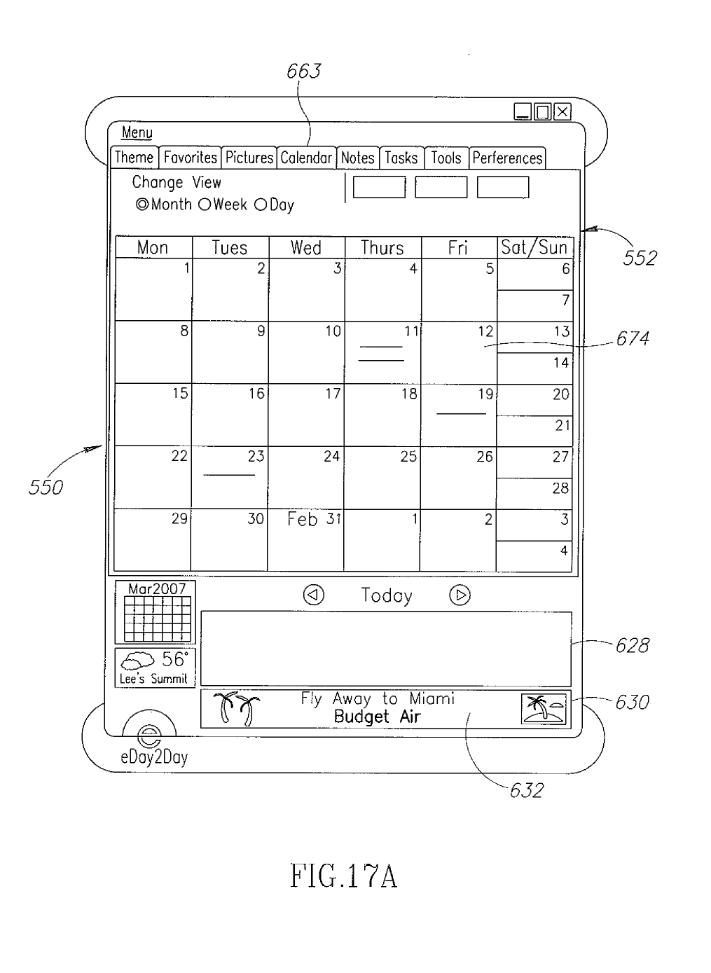

Tab 662 is for Pictures 674, as shown in the area 522 of the form 550 in FIG. 16. The Pictures 674 are typically stored in a directory in the user's computer. The user points to this directory 715 in the preference screen of FIG. 21, to import the desired picture(s) into the calendar form 550. The Pictures are typically uploaded or downloaded into the directory, in accordance with conventional programs and applications.

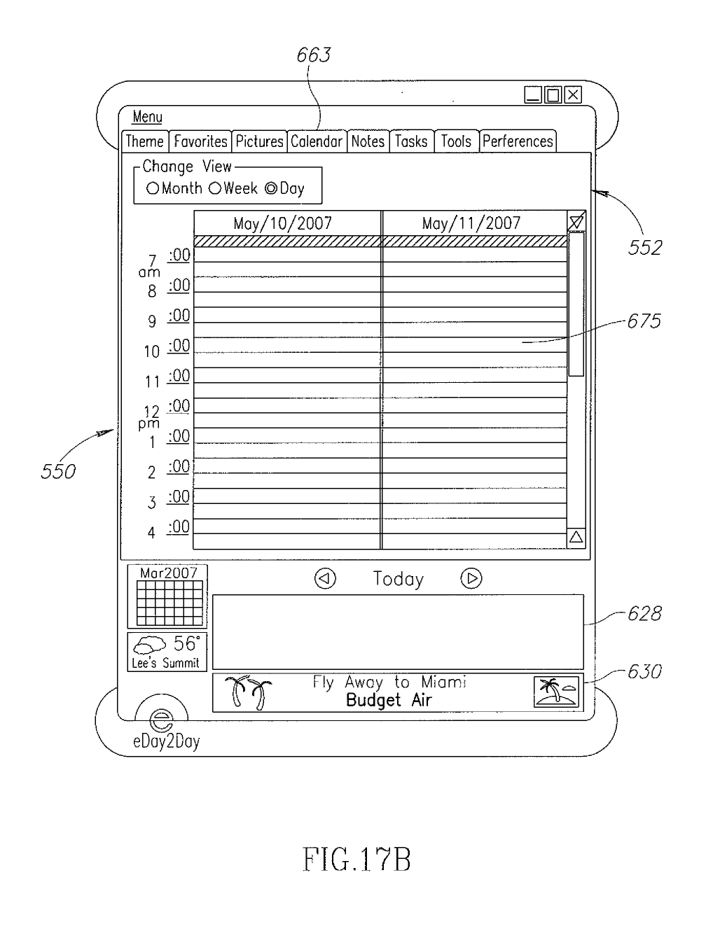

Tab 663 is for a calendar function, typically showing a calendar 674 arranged as a month, with boxes for the requisite days, in the area 552, as shown in FIG. 17A. The calendar boxes may be provided with information as filled in by the user, with conventional calendaring programs and the like. The information filled into these date blocks is imported to and appears in box 628 on the requisite date. This monthly calendar is in accordance with CC2, file 264c of FIGS. 5A-5C.

When a day is clicked, a daily page 675 appears in the area 552, as shown in FIG. 17B. The information filled into the daily page is through conventional programs and applications, and the information is imported to and appears in box 628 on the requisite date. This daily calendar is in accordance with CC3, file 264d of FIGS. 5A-5C. This daily calendar may also be such that it can set up meeting reminders and other features of a daily calendar.

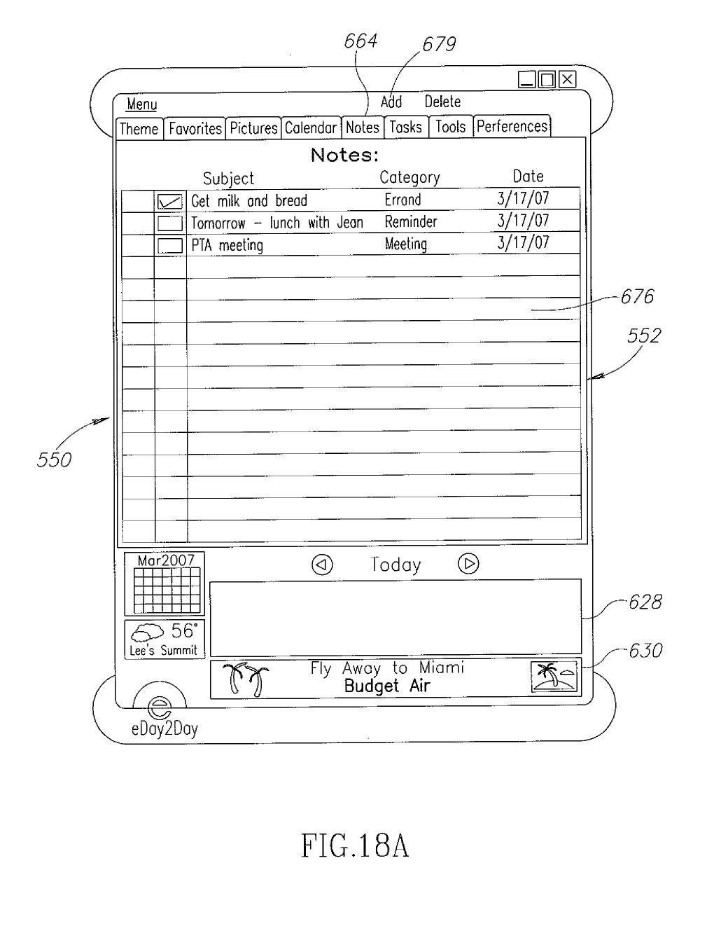

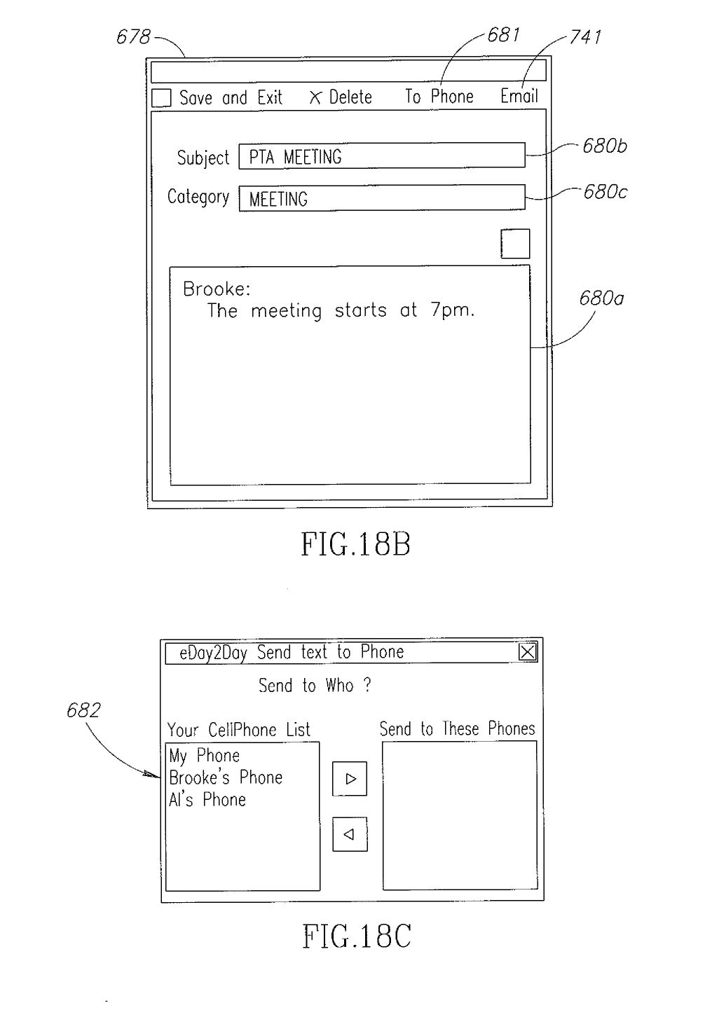

Tab 664 is for notes, entered onto a list 676 in the area 552, of the form 550, as shown in FIG. 18A. The user enters notes directly onto the list 676, in accordance with the programs in the installed NOTES file 264f, as well as conventional programs and applications. A dialog box 678, as shown in FIG. 15B, is accessed by clicking “Add” 679 on the calendar form 550 of FIG. 15A. The user can enter the desired note into the text section 680a of the dialog box 678, and that note will appear on the list 676. There is also a subject section 680b and category section 650c for the dialog box, corresponding to the “subject” and “category” for the list 676. There is also a phone list 682, as shown in FIG. 1 8C, associated with a send to phone application discussed below, may be accessed, when the “To Phone” button 681 is clicked.

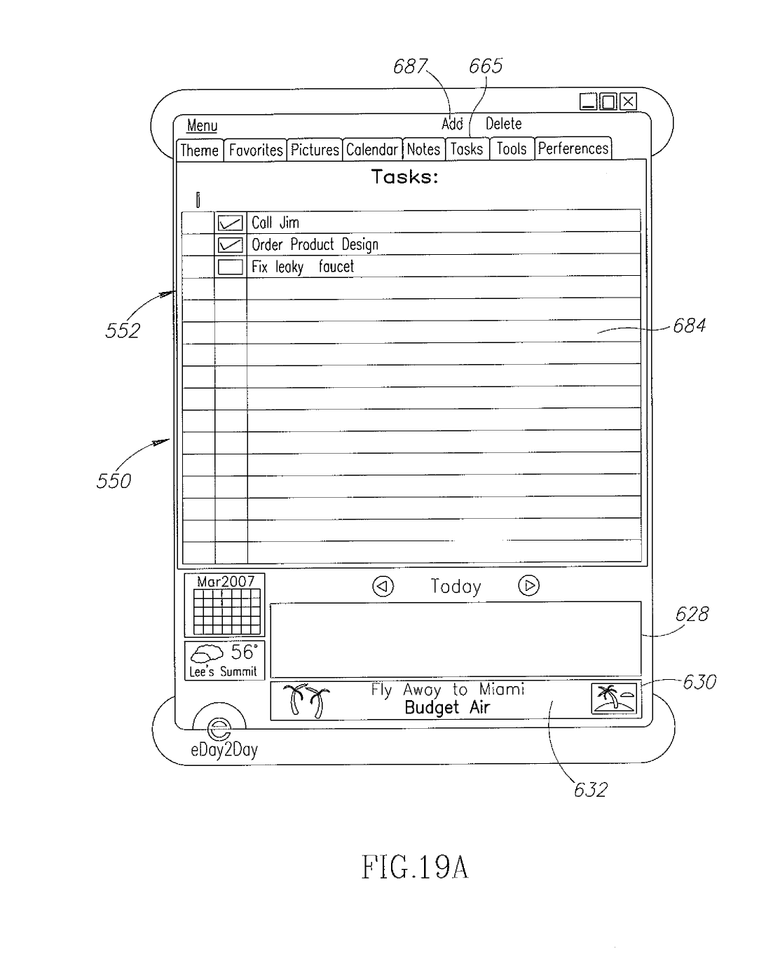

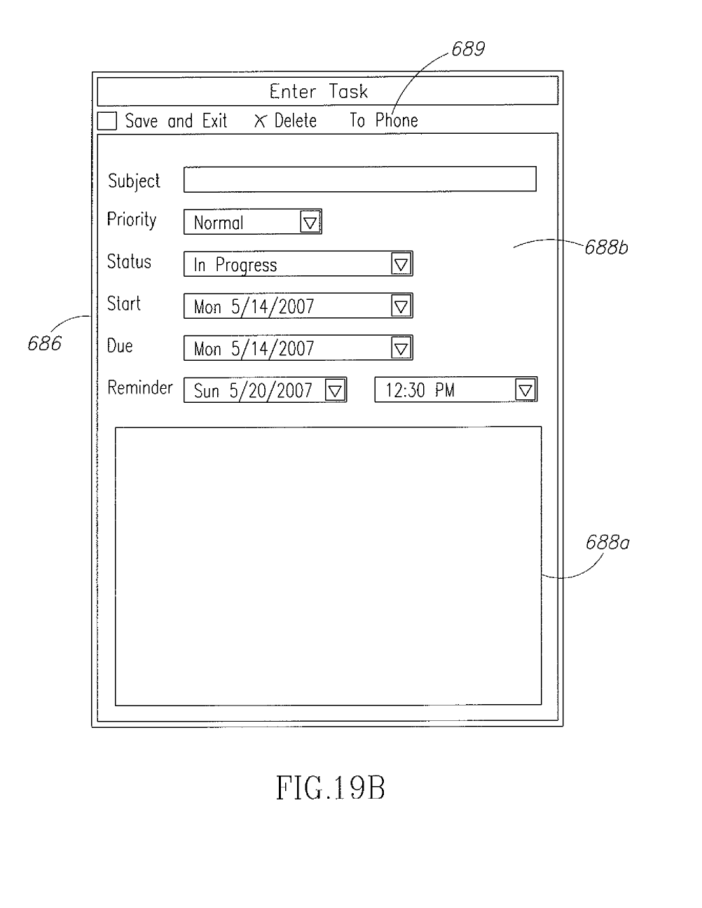

Tab 665 is for tasks, entered onto a list 684 in the area 552, of the form 550, as shown in FIG. 19A. The user enters notes directly onto the list 684, in accordance with the programs in the installed TASKS file 264g, as well as conventional programs and applications. A dialog box 686, as shown in FIG. 19B, is accessed by clicking “Add” 687 on the calendar form 550 of FIG. 19A. The user can enter the desired task into the text section 688a of the dialog box 686, and that task will appear on the list 684. There is also a head section 688b for the dialog box, for 0the task list 684. A phone list, for example, phone list 682, as shown in FIG. 18C, associated with a send to phone application discussed below, may be accessed, when the “To Phone” button 689 is clicked.

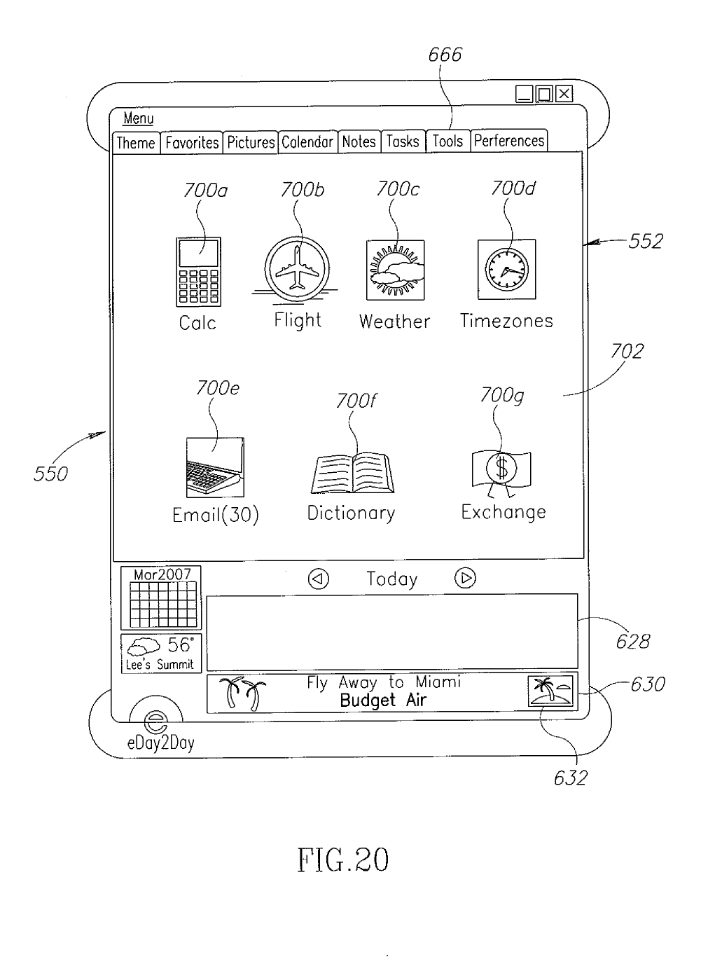

Tab 666 is for tools, that are either internal to the computer or accessed over on-line connections or pipes, to either the media server 34, third party servers, or the like. The tools are also coordinated with other applications. Tools may be added or deleted in accordance with conventional programs. Exemplary tools are represented by icons 700a-700g in the area 552 of the calendar form 550, as shown in FIG. 20. For example, tools for the calculator (icon 700a) and time zones (icon 700d), are typically internal to the computer. Tools for flights (icon 700b), weather (icon 700c), dictionary (700e) and currency exchange (icon 700g) typically cover links that when clicked will obtain this information over the Internet 24. Tools for e-mail (icon 700e) typically cover links to a network, from which the e-mail can be received, as well as internal applications of the computer. Additional tools may include, for example, those for magnifying the calendar form 550 or portions thereof, rotating the calendar page, games (e.g., Soduku, Crossword Puzzles and the like), and the like.

Preferences, represented by tab 667 will bring up a screen 710 with four areas 711-714, as shown in FIG. 21. A first area 711 is for e-mail for the user, to send e-mails. A second area 712 is for telephone contacts and e-mail contacts. Files, applications and programs are also downloaded upon the install, at FIG. 5C and detailed above, for e-mail addresses (domains) of the various cellular carriers, and for combining this information with the intended recipient's cellular telephone number, in order to facilitate sending the calendar pages 554 or items from the calendar form 550, or associated therewith to cellular telephones, PDA's and other communication devices. These phone and e-mail contacts appear as a list, in box 712a. A third area 713 includes options for calendar page size 713a and button bar size 713b, where button bars are used. There is also an area for special messages 714. The message is entered at box 714a and stored at box 714b. For example, on Mar. 29, 2007, there is a special message for “Sally's Party,” that will appear on that date as a box 627 over the calendar page 554, until removed by the user (for example, by clicking on the box 627). There is a fifth area 715 for a picture directory.

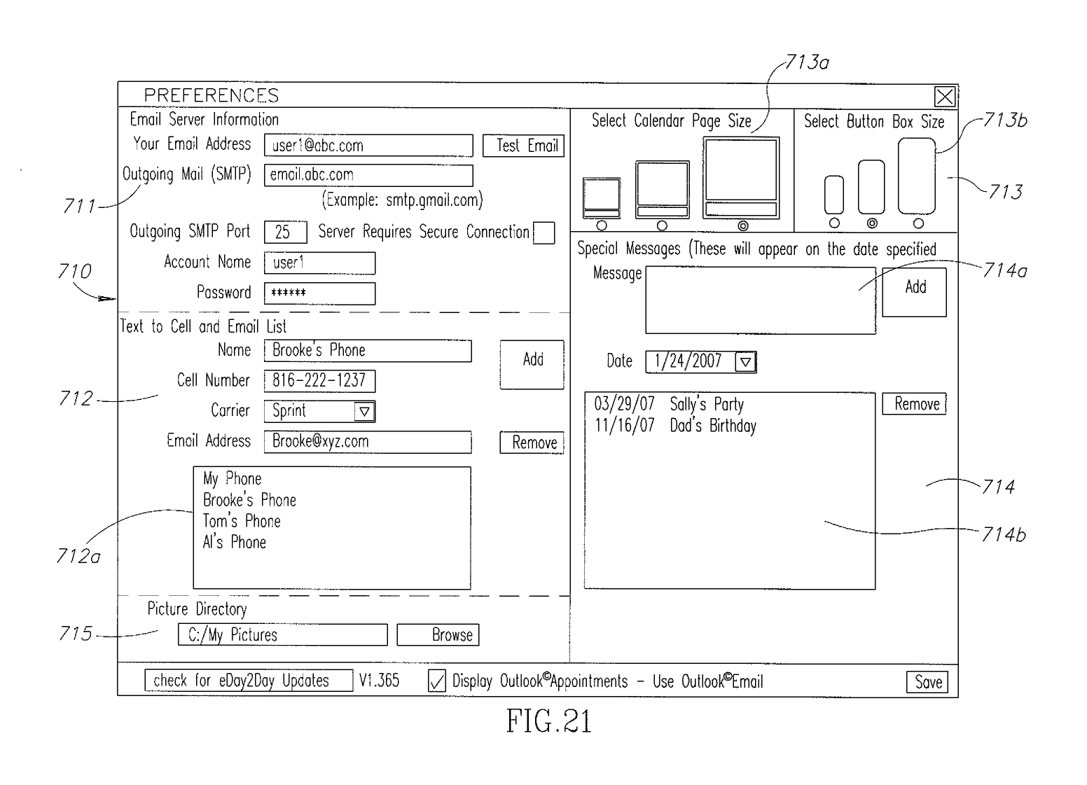

Turning back to FIG. 14, when the drop down menu 657 typically links with a conventional e-mail program or the like, as stored in the user's computer, such as an e-mail program or application from Outlook®, for example, drop down menu option “Send To” is selected, the calendar page 554 is packaged in an e-mail 730, and may be coupled with a message 732, typed by the user, and sent to an intended recipient calendar page, as shown in FIG. 22. The recipient may be typed in at the “To” line 734 of the e-mail, or selected from a stored list.

Additionally, the e-mail of FIG. 22 may be sent to a mobile telephone, PDA, or other communication device. In this case, the preference screen of FIG. 21 is accessed, and the recipient is selected from the list of box 712a. A telephone recipient, for example, “Brooke's Phone” is selected. The telephone number for this telephone is matched with the e-mail domain for the carrier used by that recipients cell phone to create an e-mail address that goes in the “To” line of the e-mail. Accordingly, Brooke's cellular telephone is 816-222-1257, her cellular carrier is Sprint®, the e-mail address in the “To” line of the e-mail 730 would be, for example, 8162221257@messaging.sprintpcs.com.

Similarly, a portion of the calendar form 550 may be sent to a cellular telephone, PDA or other communication device, or the like by one of two ways. Turning to FIG. 18A, the Notes can be sent as a text message, by activating the drop down menu button 678 and clicking on the “Send To” line. As detailed above, the user may send to a standard e-mail by typing in the e-mail address or obtaining it from a previously stored list. Additionally, the user can send these Notes as a text message to a cellular telephone, PDA or the like, by entering the address of the cellular telephone, PDA or the like, or obtaining the address for texting from the list from box 712a, as detailed above.

Alternately, from FIGS. 18B and 18C, the user can add a message to the requisite note, in the text section 680a of the dialog box 678, and send it as a text message to a cellular telephone or other wireless device by clicking on the button “To Phone” 681 of FIG. 18B. The screen 682 of FIG. 18C will appear and the user will select the intended recipient. The program 264a (FIGS. 5A-5C) that was downloaded in the install (FIG. 5C), will prepare the message for sending to the cellular telephone, PDA or the like of the intended recipient and send it as a text message.

The information of the dialog box 678, can also be sent as an e-mail, by clicking the e-mail button 741 of the dialog box 678 in FIG. 18B. The e-mail will be set up and sent as detailed above.

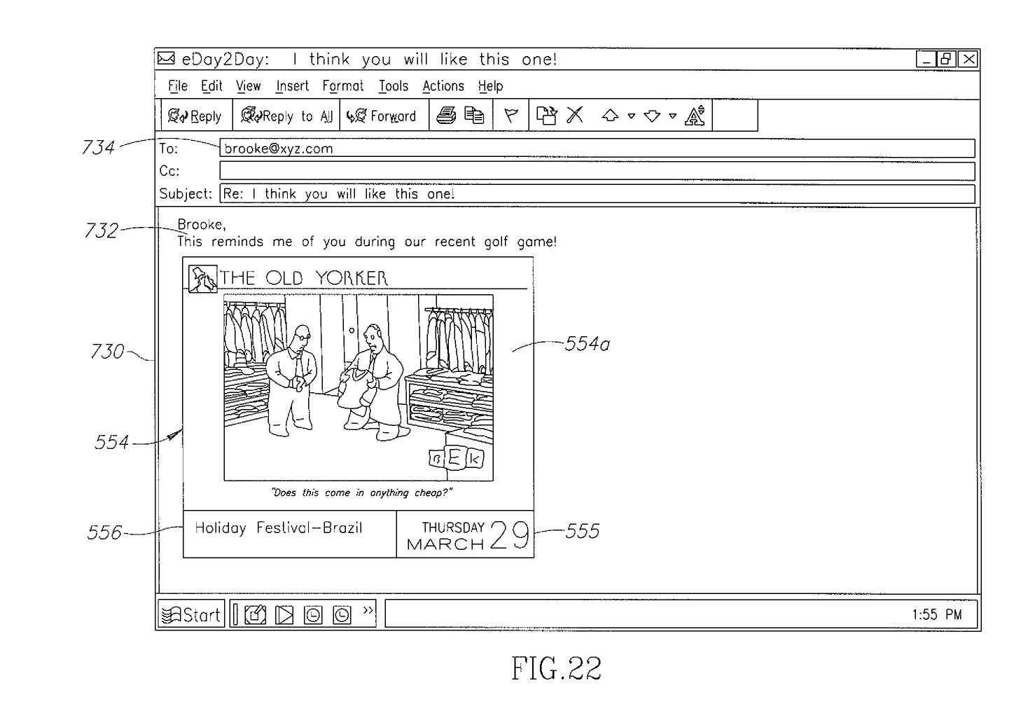

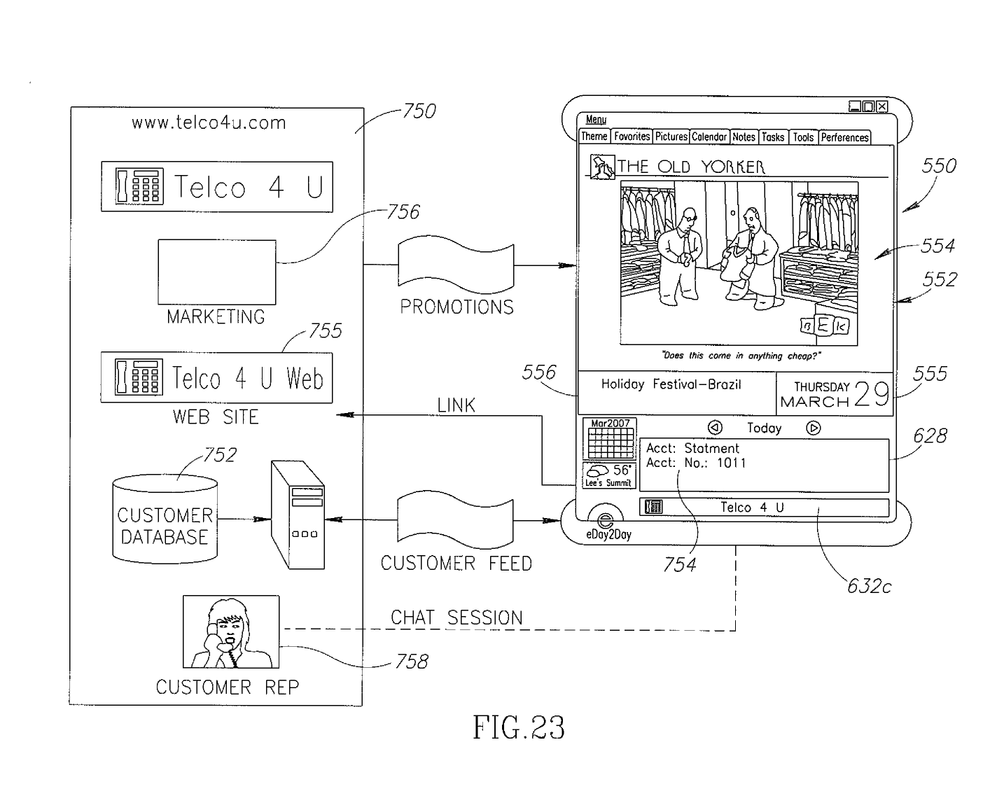

Other communications options are also permissible. For example, the calendar form 550 may be such that it links to a third party web site for multiple functions. For example, as shown in FIG. 23, the billboard 632c provides a link to the web server for the URL of www.telco4u.com, over the Internet 24, run by the telecommunications provider Telco 4 U. When the user clicks on the billboard 632c, he accesses the TelCo 4 U web site. At this web site, the user has multiple options.

He may receive customer feeds, such as RSS messages concerning his account, from the customer database 752, with the messages, such as his account statement 754 appearing in the box 628. He may also directly access information, such as his account statement from the requisite web page 755 at the web site. He may also receive marketing messages and other information from the company 756, for example, coupons, special offers and the like, that will appear in box 628. He may also set up a chat session with a customer service representative or other person at the company 758, with text being displayed and entered at box 628.

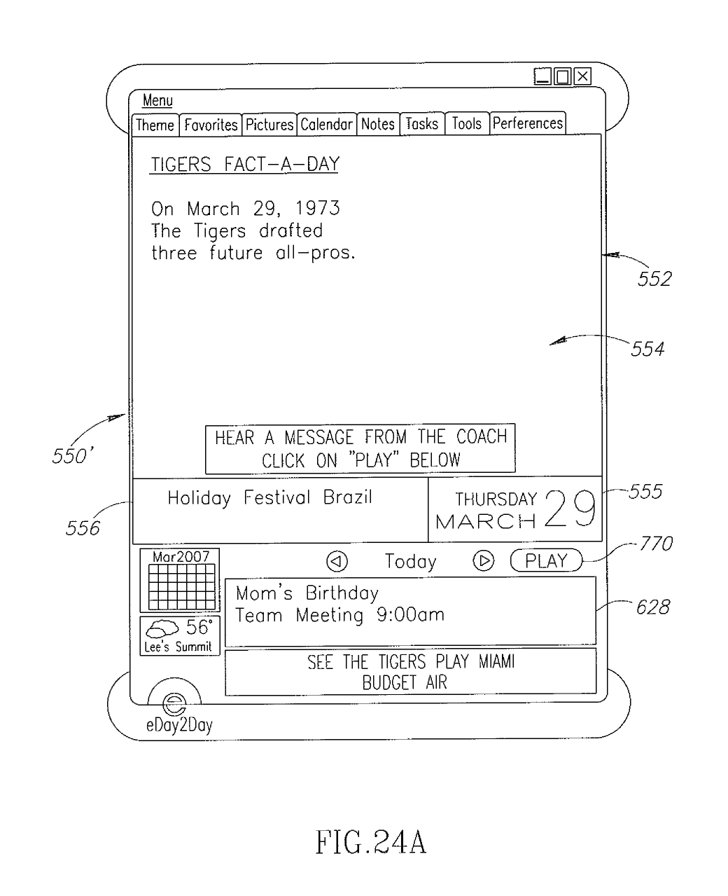

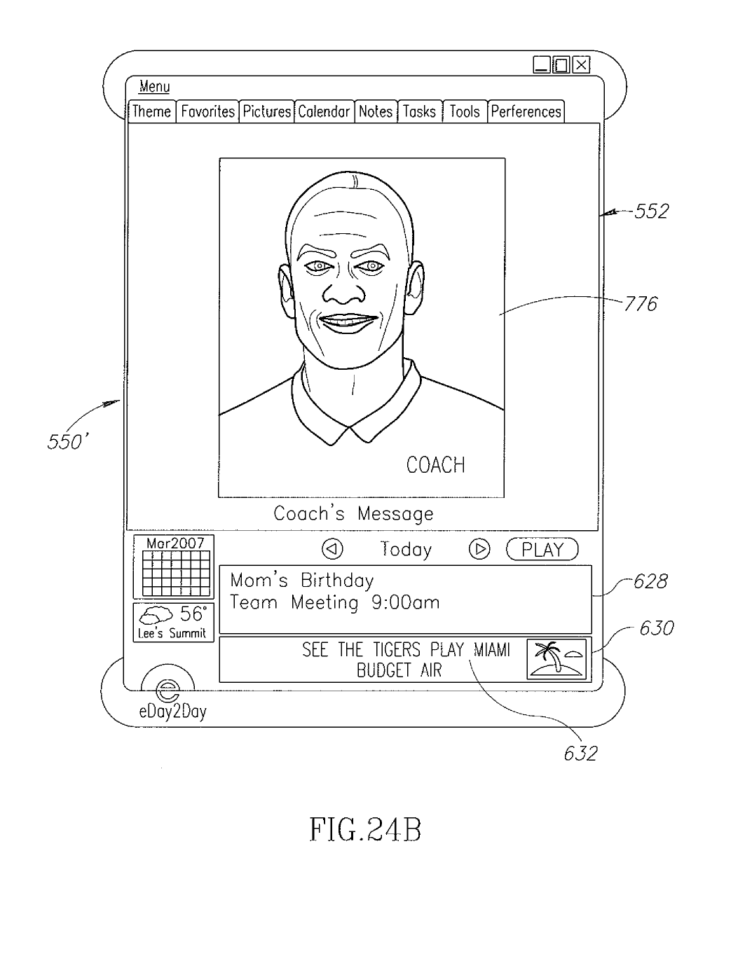

Another calendar form 550′ supports RSS and other feeds, multimedia files, video streams, video clips, audio feeds, audio streams, and combinations thereof, as shown in FIGS. 24A and 24B. In this calendar form 550′ a “PLAY” button 770 has been added. In the area 552, there is an instruction in box 772 to hear a message from the coach by clicking the “PLAY” button 770, in FIG. 24A.

When the “PLAY” button is clicked, a connection or pipe is opened over the Internet 24 between the user's computer and a third party server 48a, 48b, the third party media server 48c or the media server 34. Any of these servers can send a video clip with audio in a multimedia media file or RSS feed to the calendar page 550′, or alternately, it can be pulled by the user's computer. The received the video clip with audio 776, for example, of the coach, appears in the area 552 of the calendar form 550′. The volume, starting, stopping, pausing and the like can be controlled by conventional downloaded programs such as Media Player® and the like. Alternately, the media server 34 may redirect the connection or pipe to any one of the other servers 48a-48c, that will then send or push the video clip with audio to the calendar form 550′ of the user's computer.

Additionally, in the billboard box 630, a billboard 632 relevant to the subject matter of the calendar or video clip with audio may be placed therein. The billboard 632 covers an activatable link to a URL accessible over the Internet 24.

Alternatively, the calendar form 550′ can accommodate a calendar page for games such that when the “PLAY” 770 is clicked a entertainment module such as an interactive game will be active in the area 552 on form 550′.

Attention is now directed to FIGS. 11 and 25A-32, that detail a process and a calendar for year round purchase and use. The calendar may begin at the desired time and ran for a desired time interval. An exemplary calendar described here is one where there is page for each day (although a page for multiple days, such as weekends, is also permissible), and the calendar length or time period is for one year, and accommodates leap years. The process is described, with references to an exemplary application of the process when the calendar is bought at different times by two different users.

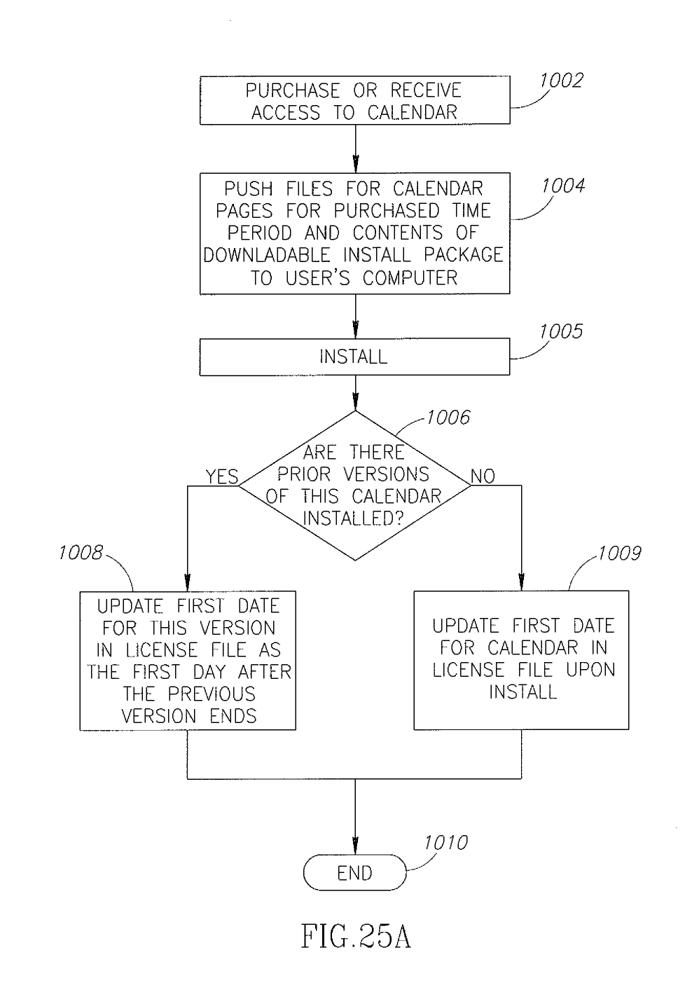

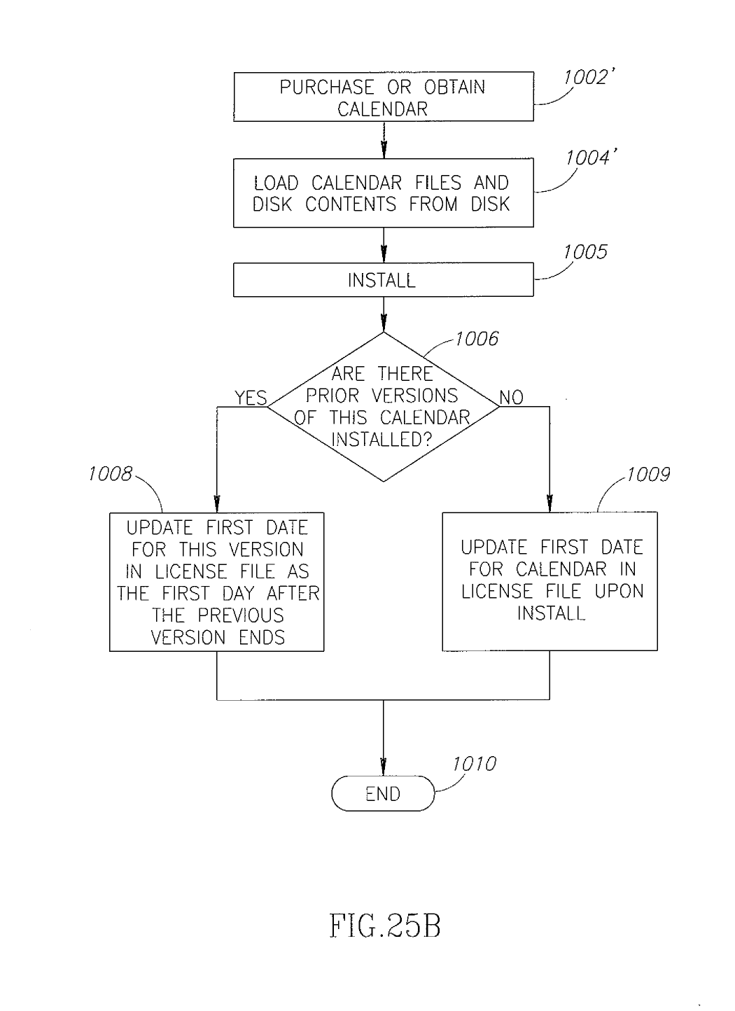

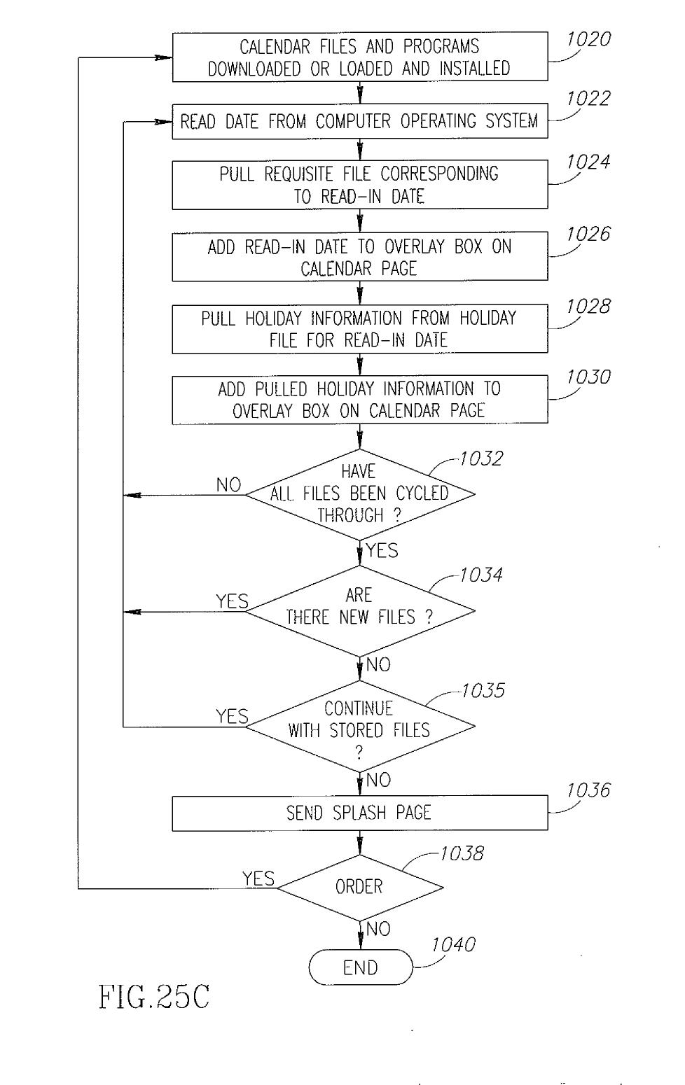

In FIG. 25A, there is detailed a process performed by the calendar providing entity 30 (FIG. 1), within one or more of the home server 32, media server 34 and/or web server 36, and in the user's computer. Initially, at block 1002, a calendar order is made, by purchasing the calendar, typically online, or access to a calendar on the data server 32b is provided to the user, so as to require its page files to be downloaded, from for example, a downloadable install package 275 (FIG. 5A), as detailed above.

The files for the desired period, a predetermined time interval, for example, a year, numbered, for example, as File001.pdf, corresponding to January 1 to File366.pdf, corresponding to December 31, including a file for a leap year (File060.pdf), shown by the table of FIG. 26 (a file for a calendar page corresponding to each date for a year), are then pulled from the data server 32b (the files may also be pushed from the data server 32b) to the requisite user's computer, at block 1004 (where the files are downloaded). The calendar page files are also pulled (or alternately, pushed) with, as part of downloading the entire contents of the downloadable install package 275 (the contents detailed above and shown in FIGS. 5A-5C). Alternately, as explained above, there may be less than 366 files as a single file may be used for more than one day such as in the case of weekends and holidays and other grouping of days.

The calendar is installed, as shown in FIG. 5C and detailed above, at block 1005. This installation is checked to see if prior versions of this calendar are installed, a version here being a prior version if it has the same license key as that for the calendar being installed, at block 1006. If a prior version was installed, the first date for updating in the license file 266 (that will be considered the start date for the calendar or the first day or date the calendar is accessible to the user) in the user's computer for the calendar is the date of the first day after the previous version ends, at block 1008. If no prior versions of this calendar have been installed, the license file 266 is updated such that the first date is the date of the install, as read from the operating system of the user's computer. In this case, this date is considered as the start date for the calendar (the first day or date the user has access to the calendar). This process ends at block 1010.

Alternately, turning to FIG. 25B, if the calendar was purchased or obtained on a disc or the like, as detailed above, block 1002′ indicates the disc purchase. At block 1004′, the files for the desired period, for example, a year, numbered, for example, as File001.pdf, corresponding to January 1 to File366.pdf, corresponding to December 31, including a file for a leap year (File060.pdf), shown by the table of FIG. 18 (a file for a calendar page corresponding to each date for a year), are then loaded into the requisite user's computer, at block 1004′, along with the other contents of the disk (the contents detailed above for the disk 272 and shown in FIGS. 5A and 5B).

The disc is installed, as shown in FIG. 5C and detailed above, at block 1005. The process moves to block 1006 and then to either of blocks 1008 or 1009, blocks 1006, 1008 and 1009 as detailed above for FIG. 25A. The process ends at block 1010, as detailed above.

Actual operation (use) of the calendar, that has been registered for purposes of this example, in a user's computer, is detailed with reference to FIG. 25C. Initially, the calendar has been downloaded or loaded, and installed, at block 1020, as detailed above. The calendar is for a time period or interval, for example, a year, is considered finished when 365 or 366 (if a leap year) files were used in a cyclic order, the cycle beginning on the start date (the start date defined as the date of the install or the date of the first day after the previous version of the same or another designated calendar ends) of the first file for the cycle of files.

As calendar use begins, the process moves to block 1022, where the date is read from the user's computer's operating system. The file for the page corresponding to the read-in date is pulled from the downloaded files, at block 1024. The file is read into (placed in) the form 550 representative of all forms 550, as shown in FIG. 11, and detailed above.

With the requisite file for the requisite calendar page pulled, corresponding to the read-in date (from the operating system of the user's computer) the date is placed into the overlay box 555, at block 1026. Similarly, the holiday file (264i of FIGS. 5A and 5B) is accessed and the requisite holidays for the requisite date of the corresponding file are pulled, at block 1028 and placed into the overlay box 556 of the calendar page 554, at block 1030.

It is then determined if all of the files for the dates of the time period have been cycled through, for example, cycling through one year, at block 1032. This is done, for example, by comparing the start date, as recorded in the license file 266 (FIGS. 5A-5C) to the read-in date from the user's computer, for example, by code inside the calendar.exe module.

If a full cycle has not occurred, the process returns to block 1022. If a full cycle has occurred, the process moves to block 1034. At block 1034, it is determined if there are new calendar files for this same or another designated calendar (collectively “new files”). If there are new files installed (and for discussion purposes here, registered) the process returns to block 1022. If there are not any new files, the process moves to block 1035.

At block 1035, the cycle may be continued, should a program have been downloaded or loaded from the downloadable install package or disc, for to continue the cycle of the stored calendar files. If the cycle is continued with the stored calendar files, the process moves to block 1022. In this situation, the calendar page files are the same as they were on that day a year ago. The only difference is that the date in the overlay box 555, is changed, as per block 1026, and the holidays 0are present in the overlay box 556 if the holiday file 264i (FIGS. 5A-5C) covers this date, as per block 1030. Should the holiday file 264i not cover this date, the overlay box 556 would be blank or would not appear over the calendar page 554.

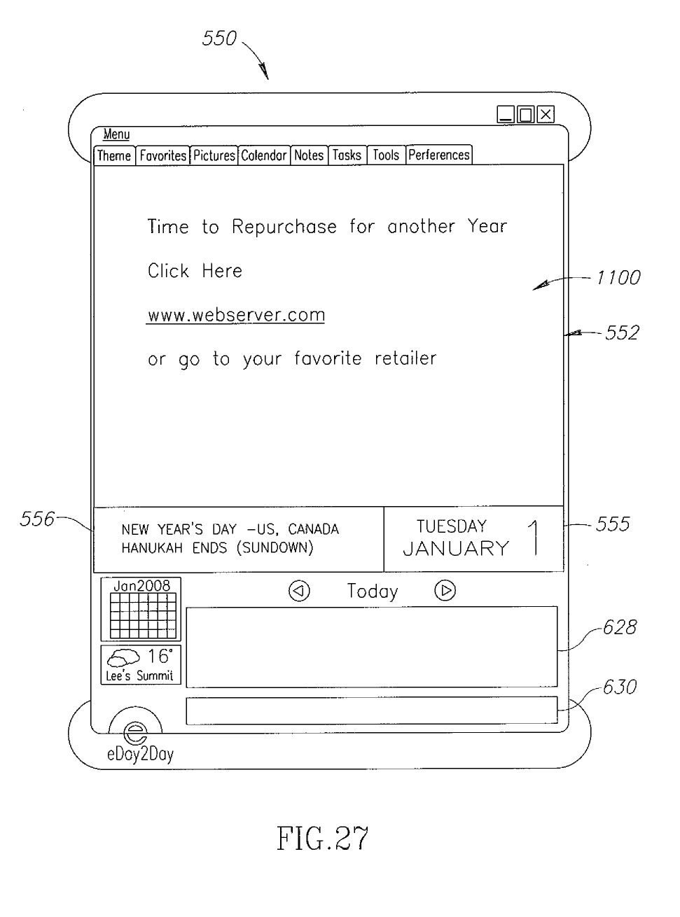

If the cycle is not continued, at block 1035, the process moves to block 1036, where a splash page 1100 from file 264n (FIGS. 5A-5C), is activated and appears in the area 552 of the form 550, as shown in FIG. 27. Alternately, block 1035 is optional and may be bypassed, such that the process moves directly from block 1034 to block 1036.

The splash page 1100 as shown in FIG. 27, typically includes a reminder that the calendar subscription is over and for the user to reorder a calendar, either online, or through a retail outlet. In the case of online ordering, there is typically provided a clickable link, for example, in hypertext mark up language (HTML) format, to allow for ordering a new calendar. For example, the link may be to the web server 36, with the URL of www.webserver.com, that when activated or clicked, directs the user's browser to a web page, such as that of FIG. 2A, that allows for direct ordering of a new calendar. If a new calendar is ordered, at block 1038, the process returns to block 1020. Otherwise, the process ends at block 1040, where the user may, for example, receive the calendar form 550 with the splash page 1100, with the overlay boxes 555, 556 (depending on the coverage of the holiday file 2641, as detailed above), or without the overlay boxes 555, 556, if the splash page file 264n is programmed accordingly.

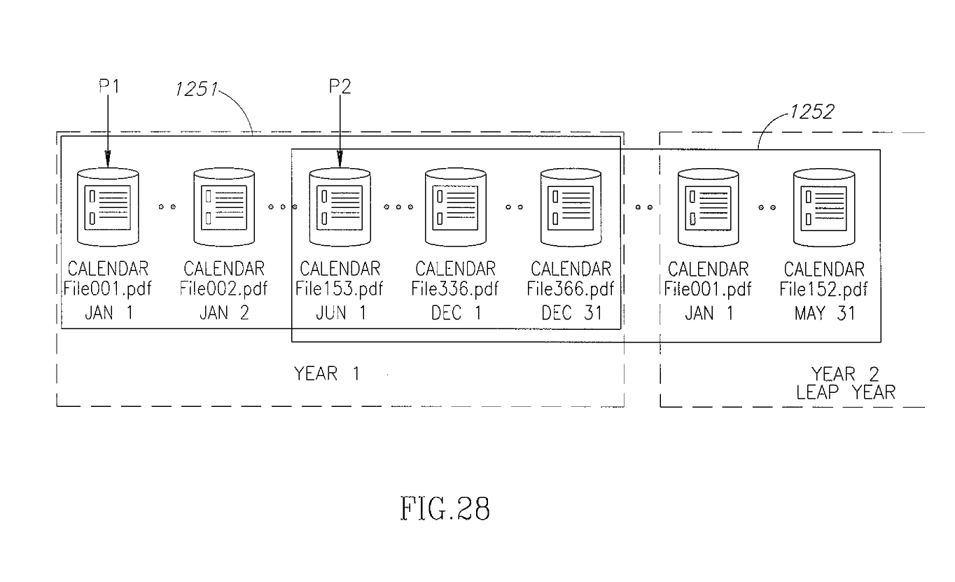

Year round ordering and use is now illustrated, for example, with reference to FIGS. 26, 27 and 29-32. For example, turning to FIG. 28, there are two subscribers (users), indicated by blocks 1251 and 1252. Also, for discussion purposes, Year 1 is a regular year of 365 days, while Year 2 is a leap year of 366 days. A year includes files that have a 365 or 366 day cycle, in the case of a leap year.

Subscriber 1 has purchased a one year calendar, running from January 1 of Year 1 to December 31 of Year 1. The start date is January 1 of Year 1, is indicated by the arrow P1. Accordingly, File001.pdf is the first file in the cycle and File366.pdf is the last file in the cycle. Subscriber 2 has purchased a one year calendar, running from June 1 of Year 1 to May 31 of Year 2. The start date is June 1 of Year 1, as is indicated by the arrow P2. Accordingly, File153.pdf is the first file in the cycle and File152.pdf is the last file in the cycle.

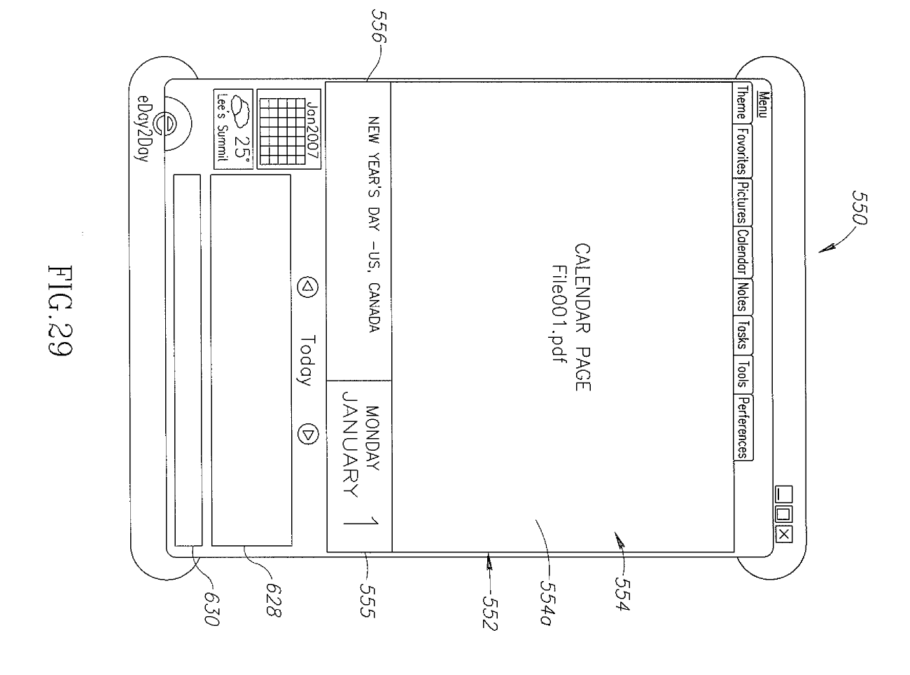

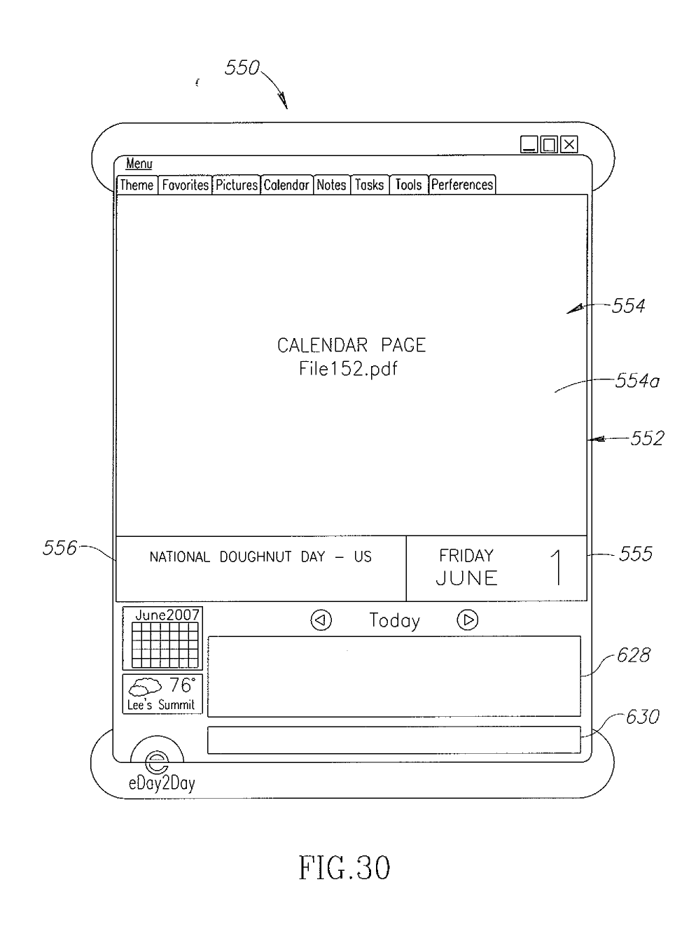

For the calendar subscription that starts on January 1 of Year 1, shown by the box 1251, on January 1, the Subscriber 1 (box 1251) sees the calendar page 554 of FIG. 29 on his monitor, once the calendar page has been activated, as detailed above. This calendar page 554 is for January 1 and is File001.pdf. Similarly, on June 1, Subscriber 1 (box 1251) and Subscriber 2 (box 1252) would see the same calendar page 554 of FIG. 30.

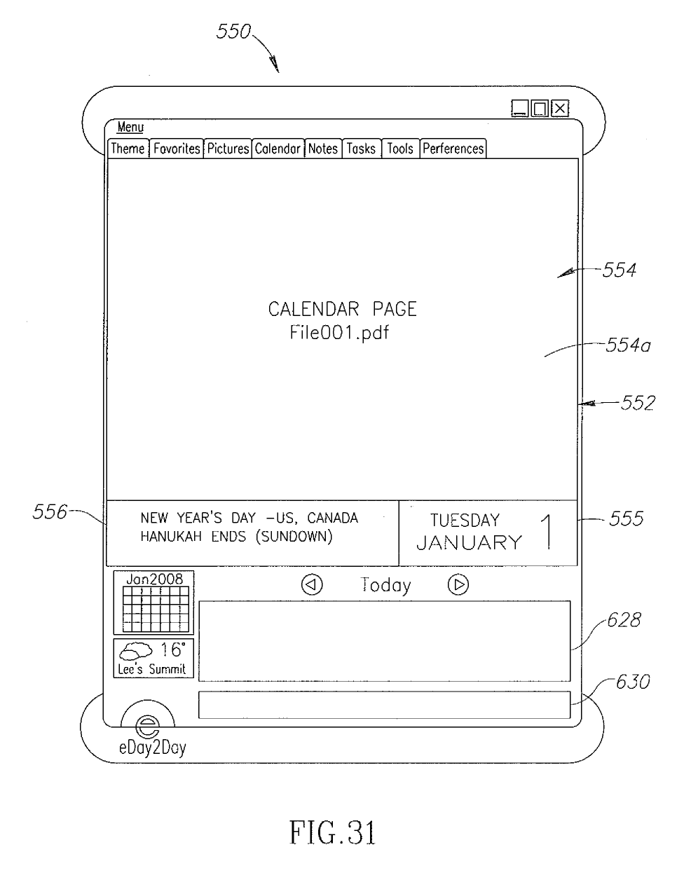

On January 1 of Year 2, Subscriber 2 sees the calendar page 554 of FIG. 31, that is the same calendar page seen by Subscriber 1 on January 1 of Year 1. However, the overlay box 555 shows different date information and overlay box 556 shows different holiday information. Subscriber 1, whose calendar has expired as of this date, will see for example, either the same calendar page 554 being viewed by Subscriber 2 (of FIG. 30), with the same date information in the overlay box 555, and the same holiday information in the overlay box 556, provided his holiday file 264i covers this date. Otherwise, the overlay box 556 will be blank or nonexistent.

Alternately, on this date, January 1 of Year 2, subscriber 1 will receive a splash page 1100 in a form 550, such as that shown in FIG. 27. This form 550 may include overlay boxes 555 and 556 with date and holiday information respectively, or just overlay box 555, with overlay box 556 being blank or nonexistent, if the holiday file 264i does not cover this date.

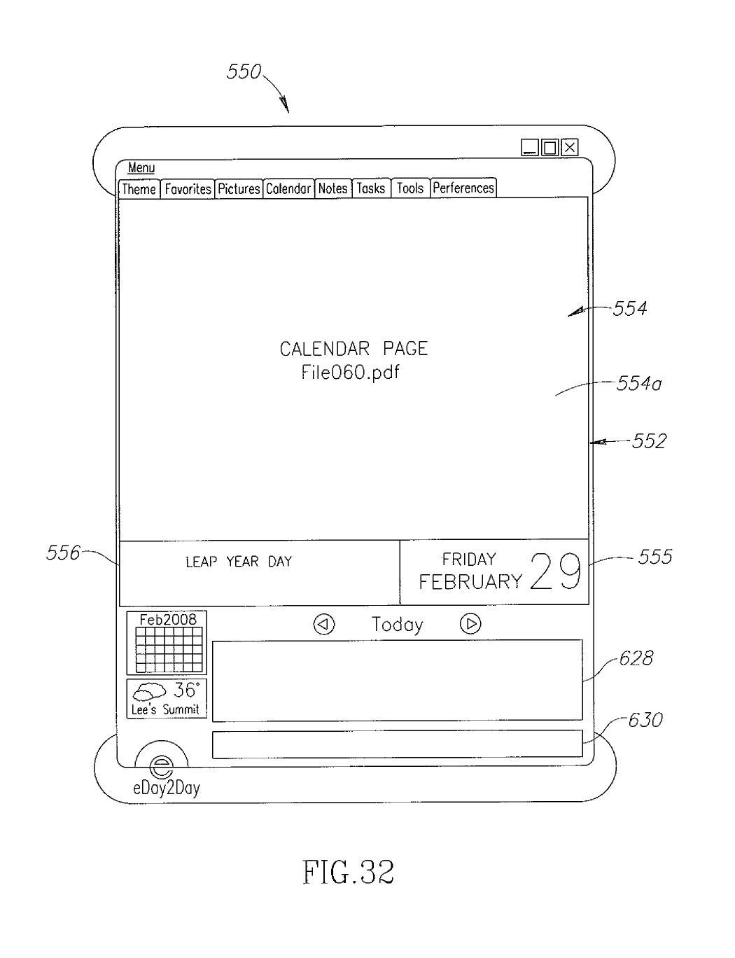

For example, should Year 2 be a leap year, the Subscriber 2 (box 1252) would see a calendar page corresponding to File060.pdf for February 29. This calendar page 550 would appear on his monitor in accordance with the screen shot of FIG. 32. Subscriber 1 (box 1251) would not have seen this page, as File060.pdf would never have been accessible to his computer, as the dates of Year 1, for which Subscriber 1 had his calendar, did not include a February 29. Alternately, Subscriber 1, would continue to see the splash page 1100 in the form 550, as detailed above.

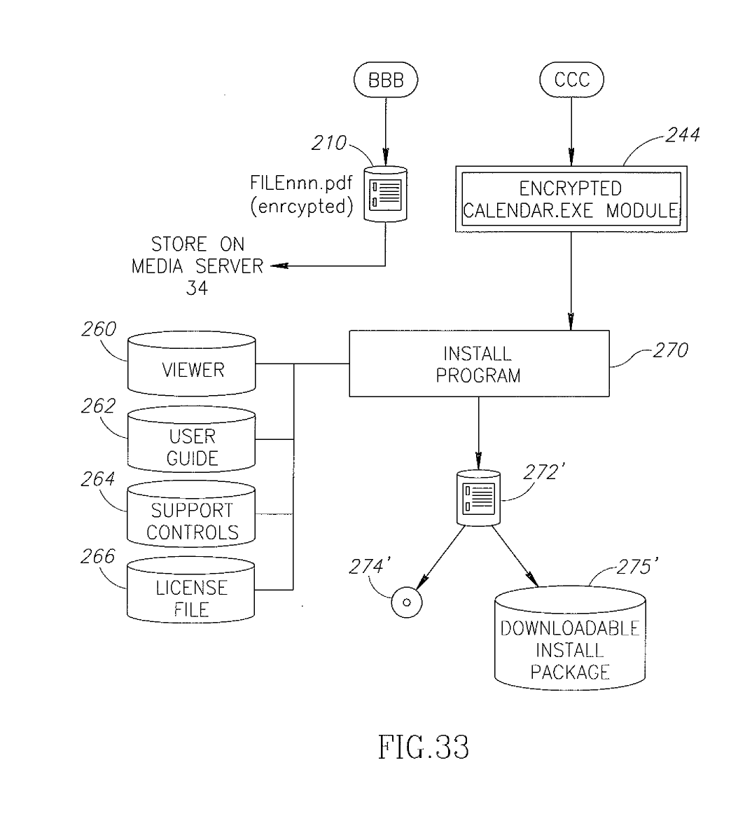

Alternately, as shown in FIGS. 33-35, the calendar page files 210 may be stored in a server, linked to a network, such as the Internet 24. These files 210 are accessible only upon opening a connection or pipe between the user's computer and the server. Other than the specific processes detailed below, all other processes are the same or similar to those as detailed above.

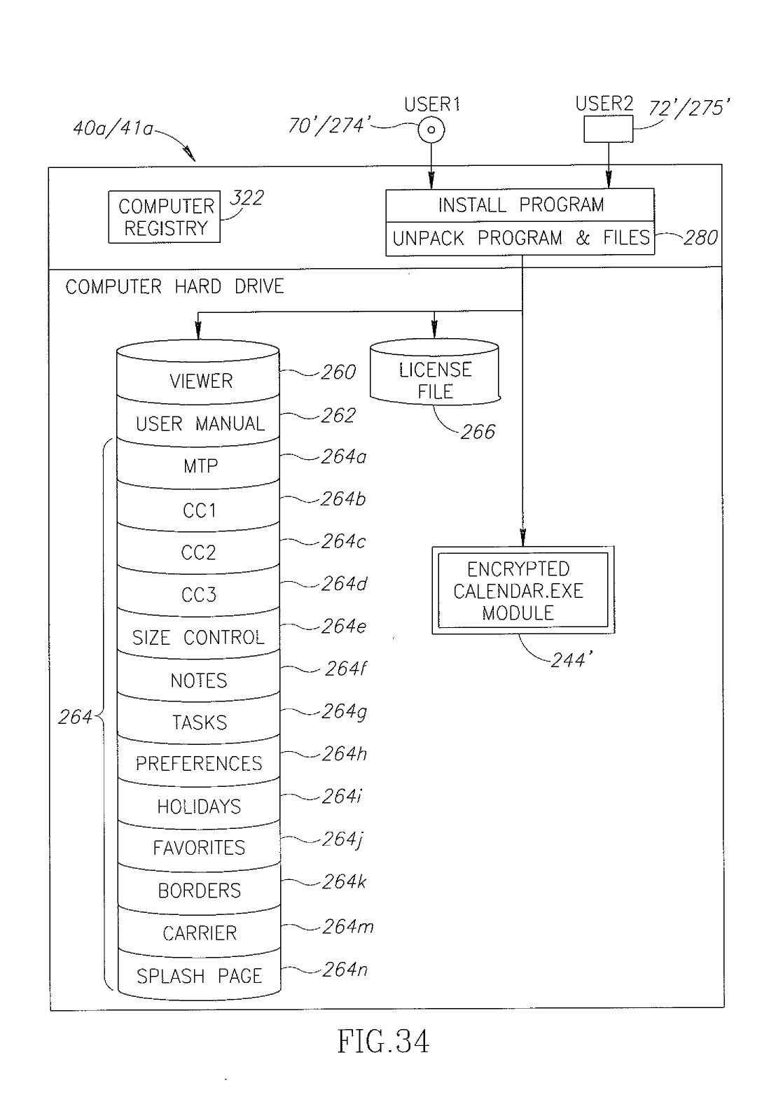

The process for creating and encrypting the calendar page files 210 and the calendar.exe module is the same as detailed above. However, as shown in FIG. 33, which is similar to FIG. 5A, the calendar page files 210 are stored on the a server, such as the media server 34 of FIG. 1. The files stored in the server may be similar to those shown in FIG. 26. Also the calendar.exe module 244′ includes programs and applications for opening a connection or pipe from the user's computer to the media server 34, once the disc 70′/274′ or downloadable install package 72′/275′ is installed in the user's computer (as shown in FIG. 34), when the icon 140 (FIG. 6A) is activated (FIG. 6B). The programs and applications are also designed to pull up the calendar form 550 (or template therefor) and pull the requisite calendar page 554 for the date, as read from the user's computer's operating system, media from the server 34. This calendar.exe module, as detailed above, then reads the requisite calendar page to the area 552 of the form 550, as detailed above.

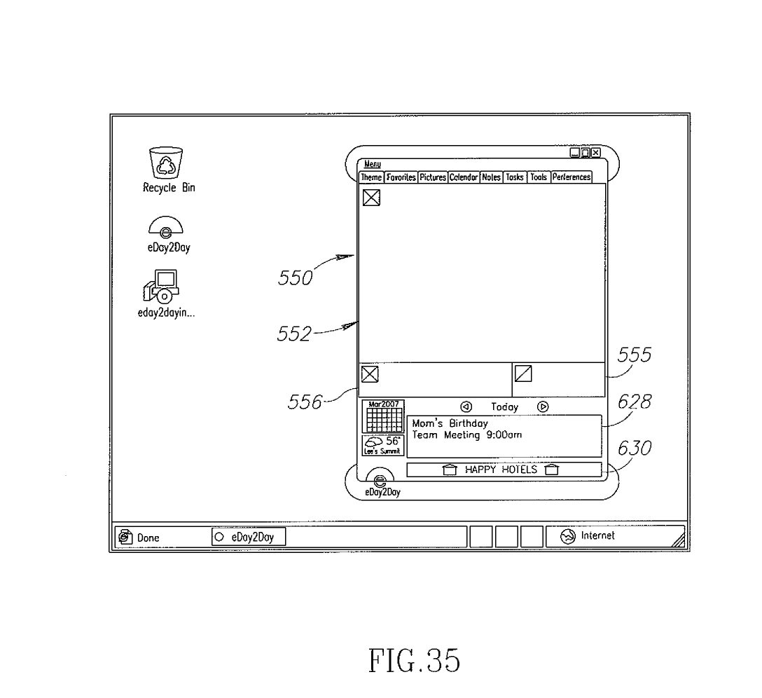

Accordingly, a calendar page may be obtained for each day via the Internet 24 or other network. As shown in FIG. 35, for each day the calendar is activated (by clicking on the icon 140, as shown for example, in FIG. 6B) the calendar.exe module 244′ opens a connection from the user's computer to the media server 34, over the Internet 24. The user's browser application or browser reads the date from the computer's operating system and makes a request to the media server 34 for the correspondingly dated calendar page file over the open connection. The browser then accesses the media server 34 and typically pulls, the corresponding calendar page file for that date. Contemporaneous in time or at the same time, a form 550 is displayed, and the files necessary for viewing the calendar page file, as detailed above, are activated in the user's computer from the calendar.exe module.

As shown in FIG. 35, the form 550 initially displays, while the calendar file is being pulled and/or read into the area 552 of the form 550. Similarly, the overlay boxes 555, 556, absent information display on the form, while they are in the process of being filled. Once the area 522 is filled with the read-in calendar page 554, and the overlay boxes are filled with the date information 555 and holiday information 556, the form 550 displays similar to the form of FIG. 10B.

This process may be performed every day for the life of the calendar to receive a calendar page 554 in a form for each day. The received calendar pages 554 may then be saved and stored in the hard drive of the user's computer or in other storage, internal or external to the user's computer. The connection or pipe may be closed automatically (if programmed in the calendar.exe module) or manually, by the user terminating the connection to the network (Internet 24).

The above described methods (processes), including portions thereof, can be performed by software, hardware and combinations thereof. These processes and portions thereof can be performed by computers, computer-type devices, workstations, processors, micro-processors, other electronic searching tools and memory and other storage-type devices associated therewith. The processes and portions thereof can also be embodied in programmable storage devices, for example, compact discs (CDs) or other discs including magnetic, optical, etc., readable by a machine or the like, or other computer usable storage media, including magnetic, optical, or semiconductor storage, or other source of electronic signals.

The processes (methods) and systems, including components thereof, herein have been described with exemplary reference to specific hardware and software. The processes (methods) have been described as exemplary, whereby specific steps and their order can be omitted and/or changed by persons of ordinary skill in the art to reduce these embodiments to practice without undue experimentation. The processes (methods) and systems have been described in a manner sufficient to enable persons of ordinary skill in the art to readily adapt other hardware and software as may be needed to reduce any of the embodiments to practice without undue experimentation and using conventional techniques.

While preferred embodiments of the present disclosed subject matter have been described, so as to enable one of skill in the art to practice the present disclosed subject matter, the preceding description is intended to be exemplary only. It should not be used to limit the scope of the disclosed subject matter, which should be determined by reference to the following claims.

What is claimed is:

1. A computer usable storage medium for storing data for an electronic calendar, comprising:
a plurality of electronic calendar page files, each of the electronic calendar page files corresponding to at least one date; and,
a module for interacting with the plurality of electronic calendar page files, the module including:
a first application for obtaining a date and accessing an electronic calendar page file corresponding to that obtained date;
a second application for retrieving the accessed electronic calendar page file; and
a third application for displaying the retrieved electronic calendar page file as an image.

2. The computer usable storage medium of claim 1, wherein the first application obtains the date from the operating system of the computer that is using the computer usable storage media.

3. The computer usable storage medium of claim 2, wherein the third application additionally creates a form into which is placed the retrieved electronic calendar page file for displaying the electronic calendar page file.

4. The computer usable storage medium of claim 3, wherein each of the electronic calendar page files corresponds to one date.

5. The computer usable storage medium of claim 4, wherein the plurality of electronic calendar page files includes a set of electronic calendar page files for one year.

6. The computer usable storage medium of claim 5, wherein the set of electronic calendar page files for one year includes at least 365 files.

7. The computer usable storage medium of claim 1, comprising a compact disc.

8. The computer usable storage medium of claim 1, comprising a downloadable install package.

9. The computer usable storage medium of claim 3, wherein the form is integratable with calendar applications and functionalities.

10. The computer usable storage medium of claim 3, wherein the form supports links that when activated provide the browsing application associated with a user's computer with a uniform resource locator.

11. A server for storing an electronic calendar, the electronic calendar downloadable over a network, comprising:
a storage medium for storing data for an electronic calendar, including:
a plurality of electronic calendar page files, each of the electronic calendar page files corresponding to at least one date;
a first application for obtaining a date and accessing an electronic calendar page file corresponding to the obtained date;
a second application for retrieving the accessed electronic calendar page file; and
a third application for displaying the retrieved electronic calendar page file as an image; and
a component for providing an application associated with the computer of a user access to the plurality of electronic calendar files, the first application, the second application and the third application.

12. The server of claim 11, wherein the first application obtains the date from the operating system of the computer that is using the computer usable storage media.

13. The server of claim 12, wherein the third application additionally creates a form into which is placed the retrieved electronic calendar page file for displaying the electronic calendar page file.

14. The server of claim 13, wherein each of the electronic calendar page files corresponds to one date.

15. The server of claim 14, wherein the plurality of electronic calendar page files includes a set of electronic calendar page files for one year.

16. The server of claim 15, wherein the set of electronic calendar page files for one year includes at least 365 files.

17. A method for distributing an electronic calendar comprising:
storing data for an electronic calendar, including:
a plurality of electronic calendar page files, each of the electronic calendar page files corresponding to at least one date;
a first application for obtaining a date and accessing an electronic calendar page file corresponding to that obtained date;
a second application for retrieving the accessed electronic calendar page file; and
a third application for displaying the retrieved electronic calendar page file as an image; and
accessing the plurality of electronic calendar files, the first application, the second application and the third application.

18. The method of claim 17, additionally comprising: loading the plurality of electronic calendar files, the first application, the second application and the third application into a computer.

19. The method of claim 17, additionally comprising: downloading the plurality of electronic calendar files, the first application, the second application and the third application into a computer over a network.

20. The method of claim 19, wherein the network includes the Internet.

21. A computer usable storage medium having a computer program embodied thereon for causing a suitably programmed system to display an electronic calendar page for a date by performing the following steps when such program is executed on the system, the steps comprising:
obtaining the date;
obtaining the stored calendar page file corresponding to the obtained date from a plurality of stored calendar page files; and
placing the obtained calendar page file into an application for it to be displayed as an image.

22. The computer usable storage medium of claim 21, wherein the steps additionally comprise:
displaying the image on a viewable computer display.

23. The computer usable storage medium of claim 21, wherein obtaining the date includes obtaining the date from the operating system of the system on which the program is executed.

24. The computer usable storage medium of claim 23, wherein the application includes a calendar form and placing the calendar page file into the form includes reading the calendar page file into a portion of the form.

25. The computer usable storage medium of claim 23, wherein obtaining the stored calendar page file includes retrieving the calendar page file from a location in the computer in which the medium is being used.

26. The computer usable storage medium of claim 21, wherein obtaining the stored calendar page file includes opening a connection over a network, from the computer in which the medium is being used to a server where the plurality of calendar pages is stored.

27. A method for year round use of an electronic calendar comprising:
providing a plurality of electronic calendar pages arranged in a cycle to cover a predetermined time period, each of the electronic calendar pages corresponding to at least one date;
designating an electronic calendar page as the first page of the cycle to be accessed; and providing access to the electronic calendar pages as of the at least one date to which the designated calendar page corresponds.

28. The method of claim 27, wherein the providing access to the calendar pages extends at least until the at least one date to which the last calendar page in the cycle corresponds.

29. The method of claim 28, wherein the predetermined time period is a year.

30. The method of claim 29, wherein the designated calendar page corresponds to any date in the year.

31. The method of claim 30, wherein the year has a first date of January 1 and a last date of December 31.

32. The method of claim 31, wherein the at least one date includes one date.

33. The method of claim 32, wherein the designated calendar page corresponds to any date in the year.

34. The method of claim 33, wherein the year has a first date of January 1 and a last date of December 31.

35. A computer usable storage medium having a computer program embodied thereon for causing a suitably programmed system to allow for year round ordering use of an electronic calendar by performing the following steps when such program is executed on the system, the steps comprising:
arranging a plurality of electronic calendar page files into a cycle to cover a predetermined time period, each of the electronic calendar pages corresponding to at least one date;
designating an electronic calendar page file as first file of the cycle to be accessed; and
providing access to the electronic calendar page files as of the at least one date to which the designated electronic calendar page file corresponds.

36. The computer usable storage medium of claim 35, wherein providing access to the electronic calendar page files extends at least until the at least one date to which the last electronic calendar page file in the cycle corresponds.

37. The computer usable storage medium of claim 36, wherein the predetermined time period is a year.

38. The computer usable storage medium of claim 37, wherein the designated electronic calendar page file corresponds to any date in the year.

39. The computer usable storage medium of claim 38, wherein the year has a first date of January 1 and a last date of December 31.

40. The computer usable storage medium of claim 36, comprising a compact disc.

41. The computer usable storage medium of claim 36, comprising a downloadable install package.

42. A method for obtaining an electronic calendar page comprising:
storing a plurality of electronic calendar page files in a storage device linked to a network, each of the plurality of electronic calendar page files corresponding to at least one date;
providing a first application for retrieving electronic calendar page files on the computer of a user;
providing a second application for displaying electronic calendar page files on the computer of a user;
receiving a request for an electronic calendar page file corresponding to a date in the request; and
providing the computer of the user access to the electronic calendar page file corresponding to the date in the request.

43. The method of claim 42, additionally comprising:
opening a connection over the network between the computer of the user and the storage device; and
retrieving the electronic calendar page file.

44. The method of claim 43, additionally comprising: displaying the electronic calendar page file as an image.

45. The method of claim 42, wherein the date in the request is obtained from the operating system in the computer of the user associated with the request.

46. The method of claim 43, wherein the network is the Internet.

47. A server for storing electronic calendar page files, accessible over a network comprising:
a storage medium for storing a plurality of electronic calendar page files, each of the plurality of electronic calendar page files corresponding to at least one date;
a first component for receiving a request for an electronic calendar page file corresponding to a date in the request; and
a second component for providing the an application associated with the computer of the user access to the electronic calendar page file corresponding to the date in the request.

48. The server of claim 47, additionally comprising, a third component for facilitating opening a connection over the network between the computer of the user and the server.
